(19) United States
(12) Patent Application Publication
(10) Pub. No.: US 2026/0097521 A1
(43) Pub. Date: Apr. 9, 2026

(54) Gripper for item movement

(71) Applicant: Dionex Softron GmbH, Germering (DE)

(72) Inventor: Til Richardsen, Kirchseeon (DE)

(21) Appl. No.: 18/905,658

(22) Filed: Oct. 3, 2024

(51) Int. Cl. B25J 15/00; B25J 15/02

(52) U.S. Cl. CPC B25J 15/0028; B25J 15/0042; B25J 15/0246

(57) ABSTRACT

The present invention relates to gripper for gripping an item. The gripper comprises a shaft extending longitudinally along an axial direction, a gripper head mounted on the shaft such that it is allowed to slide along the axial direction with respect to the shaft. The gripper head comprises a housing and at least one movable arm, wherein each movable arm is movable relative to the housing. The gripper is configured such that a relative motion along the axial direction between the shaft and the gripper head causes the at least one movable arm to move. The present invention may also relate to systems comprising the gripper, uses of the gripper and methods for gripping an item with the gripper.

### BACKGROUND

The invention is in the field of grippers for item movement. In particular, the invention is in the field of grippers used in liquid chromatography (LC), such as, in high-performance liquid chromatography (HPLC).

LC is an analytical method which aims at splitting a sample into its components in order to quantify the respective proportions. In order to avoid mixing up samples or to identify samples, automatic sample identification systems may be used. Since the attachment of a label used for sample identification on the lid may not be practical for various reasons, e.g., space limitations and recapping, attachment on the side surface of a sample container can be advantageous. Since the sample containers used are located next to each other in a sample collection container, the side surface cannot be seen-especially in the case of internal sample containers. Therefore, the sample container must be lifted out of the sample collection container for identification. A gripper may be used for this.

Grippers are already widely used in laboratory automation to grip and move sample containers. There are many different methods for the actual gripping process: gripper arms that are actuated either by motor, pneumatically, hydraulically or by electromagnet; via a suction plate that is placed on the lid of the sample container and adheres to it by means of switchable vacuum, adhesion by means of an electromagnet mounted in the gripper that exerts an attractive force on a ferromagnetic material located in the lid of the sample container, etc.

However, previous technologies have a comparatively high space requirement and/or high material costs and/or construction costs.

Space restrictions sometimes lead to a further reduction in the size of the components used, which in turn has a negative effect on wear behavior and manufacturing costs, or increases susceptibility to faults.

Aims of the present invention may thus include developing a gripper that consists of as few moving components as possible, has a robust design, contains as few active components as possible, contains as few motors, electromagnets, pneumatics, hydraulics as possible, has as little installation space as possible and requires low maintenance in frequency and/or scope.

The present invention achieves one or more of said aims.

The present invention relates to a gripper for gripping an item. The gripper comprises a shaft extending longitudinally along an axial direction and a gripper head mounted on the shaft such that it is allowed to slide along the axial direction with respect to the shaft. The gripper head comprises a housing and at least one movable arm. Each movable arm is moveable relative to the housing. A relative motion along the axial direction between the shaft and the gripper head causes the at least one movable arm to move.

The term “movable” may encompass rotatable, pivotable and/or displaceable. Similarly, the term move may encompass rotation, pivoting and/or translational motion. That is and as it will be discussed further below, the moveable arm may be a rotatable arm and/or a translatable arm. Having a movable arm may allow the gripper to grip and release items. It may further allow the gripper to securely grip items of different sizes.

The gripper of the present invention may alleviate the need of arm actuators used solely for moving the arms of the gripper. This is mainly due to the fact that relative motion along the axial direction between the shaft and the gripper head causes the at least one movable arm to move. As a result, it may be sufficient to only be able to move the shaft along the axial direction. This may be advantageous as in most applications the ability to move the shaft along the axial direction is implemented for approaching and/or displacing the item.

The number of moving parts can also be reduced. For example, motion transfer parts (such as gears) that would otherwise be required to transfer motion from an arm actuator to the arm can be eliminated.

All in all, the present invention may provide a compact and robust gripper, which can be less prone to damage, have low maintenance requirements and require small installation space.

The housing may comprise a housing bore configured to receive the shaft.

The housing bore may comprise a bore axis parallel to the axial direction. The bore axis may herein refer to a longitudinal axis of the housing bore that may extend through a geometric center of the housing bore. That is, the housing bore may generally be longitudinal and oriented along the axial direction.

The housing bore can be centrally located in the housing. That is, the bore axis may coincide with a longitudinal central axis of the housing. This may provide more stability and balance of the gripper.

The housing bore may comprise a proximal bore end and a distal bore end, wherein the shaft can be inserted in the housing bore from the distal bore end towards the proximal bore end. The proximal bore end is more proximal than the distal bore end.

Throughout the description, the terms “proximal” and “distal” are used to describe positions along the axial direction. It will be understood that for all uses of “proximal” and “distal” the same point of reference is used. Said point of reference may be a point of attachment between the gripper and the item. In particular, the term proximal is defined as situated (i.e. positioned) nearer to the point of reference and the term distal is defined as situated (i.e. positioned) away from the point of reference.

The gripper may approach the item along the axial direction by becoming more proximal to the item, i.e., by moving from a distal position to a more proximal position.

Moreover, the terms “proximal” and “distal” express a relative positioning between same parts. For example, an element of the gripper may comprise a proximal part A and a distal part A. This is to be understood that the proximal part A is closer to the point of reference than the distal part A. Said element of the gripper may also comprise a proximal part B and a distal part B. Similarly, this is to be understood that the proximal part B is closer to the point of reference than the distal part B. However, unless otherwise specified in the description, it is not necessary, that the proximal part B is closer to the point of reference than the distal part A or that that the proximal part A is closer to the point of reference than the distal part B.

Simply put, the terms “proximal” and “distal” can be defined from the perspective of the item, particularly, in the arrangement wherein the item is about to be gripped by the gripper.

The housing bore and the shaft may be configured to allow a clearance fit between each other. This may allow sliding of the shaft inside the housing bore.

The relative motion may comprise sliding of the shaft in the housing bore.

The housing may comprise a proximal housing end and a distal housing end, wherein the shaft can be inserted in the housing from the distal housing end towards the proximal housing end. The proximal housing end is more proximal than the distal housing end.

The relative motion may arrange the gripper head in different relative positions with respect to the shaft. The relative positions may be continuously distributed along the axial direction.

Some of the relative positions may be stable positions, wherein in each stable position a holding force may keep the gripper head and the shaft fixed to each other. That is, the stable positions may be a subset of all the relative positions between the gripper head and the shaft. In each stable position, the gripper may be in equilibrium.

The holding force may hinder relative motion along the axial direction between the gripper head and the shaft, while the gripper can be in each of the stable positions.

The stable positions may comprise at least one open position and a closed position. Having these positions may facilitate gripping, securely holding and unlatching the item.

For example, the stable positions may comprise one open position and one closed position, wherein the shaft can be inserted further into the housing bore when the gripper can be in the open position than when the gripper can be in the closed position. That is, the gripper may transition from the closed position to the open position by further pushing the shaft into the housing. This may allow releasing an item after gripping.

One of the at least one open position can be a proximal open position.

The shaft can be inserted further into the housing bore when the gripper can be in the proximal open position than when the gripper can be in the closed position. That is, the gripper may transition from the closed position to the proximal open position by further pushing the shaft into the housing. This may allow releasing an item after gripping.

The shaft can be inserted most into the housing bore when the gripper can be in the proximal open position.

One of the at least one open position can be a distal open position.

The shaft can be inserted further into the housing bore when the gripper can be in the closed position than when the gripper can be in the distal open position. That is, the gripper may transition from the distal open position to the closed position by further pushing the shaft into the housing. This may allow inserting the item further in the gripper (while the gripper is in the distal open position) and then securing the item by moving the shaft further in the housing (which causes the gripper to transition from the distal open position to the closed position).

The shaft can be inserted further into the housing bore when the gripper can be in the proximal open position than when the gripper can be in the distal open position.

In each of the at least one open position, the at least one movable arm can be positioned to allow release of the item, and in the closed position, the at least one movable arm can be positioned to grip the item.

Simply put, the proximal open position and the distal open position may differ on the relative position between the shaft and the housing. Otherwise, they may represent similar states of the gripper. In particular, the relative position between the at least one moveable arm and the housing may be the same for the proximal open position and the distal open position.

On the other hand, the closed position may differ from the open position(s) not only on the relative position between the shaft and the housing, but also on the relative position between the at least one moveable arm and the housing.

Having a closed position and one or more open position(s) may be advantageous as it may allow gripping and releasing the item.

On the other hand, having multiple open positions may be advantageous as it may streamline gripping the item. In particular, the at least one movable arm may be opened, closed and re-opened via a relative motion in a single direction along the axial direction between the shaft and the gripper head.

In each of the least one open position a pushing force may push the at least one movable arm away from the shaft. The pushing force may emerge, may become larger than a threshold required to push the at least one movable arm away from the shaft and/or may become maximum during the at least one open position. That is, as the relative arrangement between the gripper head and the shaft approaches the at least one open position, the pushing force may increase. It can reach its maximum when the gripper head and the shaft can be perfectly aligned at the at least one open position. It will be understood that perfect alignment may not be necessary and that misalignment may be tolerated. In particular, it can be sufficient for the pushing force to be larger than a threshold required to push the at least one movable arm away from the shaft.

A magnitude of the pushing force may depend on the position of the gripper head along the axial direction with respect to the shaft.

In the closed position a pulling force may pull the at least one movable arm towards the shaft. The pulling force may emerge, may become larger than a threshold required to pull the at least one movable arm towards the shaft and/or may become maximum during the closed position. That is, as the relative arrangement between the gripper head and the shaft approaches the closed position, the pulling force may increase. It can reach its maximum when the gripper head and the shaft can be perfectly aligned at the closed position. It will be understood that perfect alignment may not be necessary and that misalignment may be tolerated. In particular, it can be sufficient for the pulling force to be larger than a threshold required to pull the at least one movable arm towards the shaft.

The pulling force may also form the holding force keeping the gripper head and the shaft fixed to each other. For example, the gripper may be configured such that the pulling force is larger than the weight of the gripper head and the item. This can allow the gripper to securely transport the item.

A magnitude of the pulling force may depend on the position of the gripper head along the axial direction with respect to the shaft.

When the gripper can be in the at least one open position the pushing force can be larger than the pulling force. That is, traces of the pulling force may also be present during the at least one open position. However, the pushing force can be larger than the pulling force during the at least one open position, thus causing the at least one moveable arm to move away from the shaft.

When the gripper can be in the closed position the pulling force can be larger than the pushing force. Similarly, traces of the pushing force may also be present during the closed position. However, the pulling force can be larger than the pushing force during the closed position, thus causing the at least one movable arm to move towards the shaft.

The shaft may comprise a proximal shaft end configured to be inserted in the housing.

The shaft may comprise a distal shaft end opposite the proximal shaft end. The distal shaft end may typically be external and remote from the housing. For example, the distal shaft end may be connected to a machine controlling and/or utilizing the gripper.

Wherein the shaft may extend longitudinally from the proximal shaft end to the distal shaft end.

The shaft may comprise a shaft magnet firmly attached to the shaft. The shaft magnet may facilitate moving the at least one moveable arm. In particular, the shaft magnet may facilitate generating the pushing force and/or the pulling force. The shaft magnet may also facilitate generating the holding force keeping the shaft and the gripper head fixed to each other during the stable positions.

The shaft magnet can be a permanent magnet. This may provide a more compact gripper as it can alleviate the need of electrical components to generate electromagnetic force.

The shaft magnet can be positioned near or at the proximal shaft end. Thus, the shaft magnet may contact the proximal bore end. This may facilitate generating a sufficient holding force.

The shaft magnet may comprise a proximal shaft magnetic pole and a distal shaft magnetic pole which may be arranged along the axial direction and may comprise opposite polarities. That is, the magnetic orientation of the shaft magnet may be along the axial direction. This may allow relative motion along the axial direction between the shaft and the gripper head to effect motion of the at least one moveable arm.

The proximal shaft magnetic pole can be closer to the proximal shaft end than the distal shaft magnetic pole.

Each movable arm may comprise a joint arm end and a free arm end.

The joint arm end can be inside the housing and the free arm end can be outside the housing. It will be understood, that the joint arm end may also be on the housing, i.e., not necessary inside the housing. In general, the joint arm end may be joined to the housing.

Each movable arm may extend longitudinally from the joint arm end to the free arm end.

At least one movable arm can be rotatably mounted to the housing at or near the joint arm end.

The gripper may further comprise at least one arm magnet firmly attached to a respective one of the at least one movable arm. Each arm magnet may allow the respective moveable arm whereto it is attached to be affected by the shaft and in particular by the shaft magnet. Different relative positions between the shaft magnet and the at least one arm magnet may change the force therebetween, thus causing the arms to move towards or away from the shaft. The different relative positions between the shaft magnet and the at least one arm magnet may be realized via the relative motion along the axial direction between the shaft and the gripper head.

Each arm magnet can be a permanent magnet.

Each arm magnet may comprise the same or similar position along the axial direction. Therefore, each arm can be affected in the same or similar way by the shaft magnet.

The shaft magnet and the at least one arm magnet may be arranged such that in each of the at least one open position there can be a dominant magnetic repulsion force between the shaft magnet and each of the at least one arm magnet and in the closed position there can be a dominant magnetic attraction force between the shaft magnet and each of the at least one arm magnet.

The shaft magnet and the at least one arm magnet may be arranged such that in each of the at least one open position at least one magnetic pole of the shaft magnet may comprise the same or similar position along the axial direction with a same magnetic pole of each arm magnet and in the closed position at least one magnetic pole of the shaft magnet may comprise the same or similar position along the axial direction with an opposite magnetic pole of each arm magnet.

The shaft magnet and the at least one arm magnet may be arranged such that the shaft magnet may comprise a reverse magnetic orientation with each of the at least one arm magnet.

The pushing force may comprise a magnetic repulsion force between the shaft magnet and each of the at least one arm magnet.

The pulling force may comprise a magnetic attraction force between the shaft magnet and the at least one arm magnet.

The holding force, while the gripper can be in the closed position, may comprise a magnetic attraction force between the shaft magnet and the at least one arm magnet.

Each arm magnet may comprise a proximal arm magnetic pole and a distal arm magnetic pole which may be arranged along a longitudinal direction of the respective arm and may comprise opposite polarities. The proximal arm magnetic pole may be more proximal than the distal arm magnetic pole.

The proximal arm magnetic pole can be of the same polarity for each arm magnet and the distal arm magnetic pole can be of the same polarity for each arm magnet.

The proximal arm magnetic pole can be closer to the free arm end than the distal arm magnetic pole.

The distal shaft magnetic pole and the distal arm magnetic pole of each arm magnet may comprise opposite polarities.

The proximal shaft magnetic pole and the proximal arm magnetic pole of each arm magnet may comprise opposite polarities.

The housing may comprise a proximal housing magnetic element. This can facilitate generating the holding force during one or more of the stable positions, preferably during an open position, more preferably during the proximal open position. The proximal housing magnetic element may interact with the shaft magnet to thereby generate the holding force.

The proximal housing magnetic element may comprise a material that can be attractable by a magnetic field. As such, the holding force may emerge due to attraction between the proximal housing magnetic element and the shaft magnet.

The proximal housing magnetic element can be positioned inside the housing bore. Thus, the shaft magnet may be brought into proximity and preferably in contact with the proximal housing magnetic element.

The proximal housing magnetic element can be positioned near or at the proximal bore end. This way, the shaft magnet may contact or be brought in close proximity with the proximal housing magnetic element when (almost) fully inserted in the housing bore.

The proximal housing magnetic element can be closer to the proximal housing end than each arm magnet.

A distance between the proximal housing magnetic element and the shaft magnet can be at minimum while the gripper is in the proximal open position. Therefore, in the proximal open position, the holding force can be generated with a sufficient strength by the shaft magnet and the proximal housing magnetic element to make the proximal open position a stable position.

The proximal housing magnetic element and the shaft magnet may be magnetically attached to each other while the gripper can be in the proximal open position. This way the magnetic attraction between the proximal housing magnetic element and the shaft magnet may be maximized.

The shaft magnet and the proximal housing magnetic element may be configured such that there can be a magnetic attraction force between the shaft magnet and the proximal housing magnetic element.

Said magnetic attraction force between the shaft magnet and the proximal housing magnetic element can be along the axial direction. Thus, the magnetic attraction force between the shaft magnet and the proximal housing magnetic element can resist relative motion along the axial direction between the shaft and the gripper head.

While the gripper can be in the closed position said magnetic attraction force between the shaft magnet and the proximal housing magnetic element can be smaller than a force required to generate the relative motion between the gripper head and the shaft.

The holding force, while the gripper can be in the proximal open position, may comprise said magnetic attraction force between the shaft magnet and the proximal housing magnetic element.

The proximal housing magnetic element may comprise a proximal ferromagnetic element.

The proximal housing magnetic element may comprise a proximal housing magnet.

The proximal housing magnet can be a permanent magnet.

The magnetic poles of the proximal housing magnet may be arranged along the axial direction.

The proximal housing magnet and the shaft magnet may be arranged such that they may comprise the same magnetic orientation.

The proximal housing magnet and the at least one arm magnet may be arranged such that the proximal housing magnet may comprise a reverse magnetic orientation with each of the at least one arm magnet.

The housing may comprise a distal housing magnetic element. This can facilitate generating the holding force during one or more of the stable positions, preferably during an open position, more preferably during the distal open position. The distal housing magnetic element may interact with the shaft magnet to thereby generate the holding force.

The distal housing magnetic element may comprise a material that can be attractable by a magnetic field. As such, the holding force may emerge due to attraction between the distal housing magnetic element and the shaft magnet.

The distal housing magnetic element can be closer to the distal housing end than each arm magnet.

Each arm magnet can be positioned along the axial direction between the distal housing magnetic element and the proximal housing magnetic element.

A distance between the distal housing magnetic element and the shaft magnet can be at minimum while the gripper is in the distal open position. Therefore, in the distal open position, the holding force can be generated with a sufficient strength by the shaft magnet and the distal housing magnetic element to make the distal open position a stable position.

The shaft magnet and the distal housing magnetic element may be configured such that there can be a magnetic attraction force between the shaft magnet and the distal housing magnetic element. Thus, the magnetic attraction force between the shaft magnet and the distal housing magnetic element can resist relative motion along the axial direction between the shaft and the gripper head.

Said magnetic attraction force between the shaft magnet and the distal housing magnetic element may comprise a force component that can be perpendicular to the axial direction.

While the gripper can be in the closed position said magnetic attraction force between the shaft magnet and the distal housing magnetic element can be smaller than a force required to generate a relative motion between the gripper head and the shaft.

The holding force, while the gripper can be in the distal open position, may comprise said magnetic attraction force between the shaft magnet and the distal housing magnetic element.

The distal housing magnetic element may comprise a distal ferromagnetic element.

The distal housing magnetic element may comprise a distal housing magnet.

The distal housing magnet can be a permanent magnet.

The magnetic poles of the distal housing magnet may be arranged along the axial direction.

The distal housing magnet and the shaft magnet may be arranged such that they may comprise the same magnetic orientation.

The distal housing magnet and the proximal housing magnet may be arranged such that they may comprise the same magnetic orientation.

The distal housing magnet and the at least one arm magnet may be arranged such that the distal housing magnet may comprise a reverse magnetic orientation with each of the at least one arm magnet.

The gripper may further comprise at least one arm pin, wherein each arm pin can be attached to a respective movable arm and may protrude from the respective movable arm towards the shaft. Each arm pin may allow the respective moveable arm whereto it is attached to be affected by the shaft. Different relative positions between the shaft and the at least one arm pin may change the force therebetween, thus causing the arms to move towards or away from the shaft. The different relative positions between the shaft and the at least one arm pin may be realized via the relative motion along the axial direction between the shaft and the gripper head.

Each arm pin can be configured to contact the shaft. This can allow shaping the shaft such that different stable positions can be realized and in particular at least one open position and the closed position.

The shaft may comprise a narrow shaft portion and a wide shaft portion comprising different positions along the axial direction. The narrow shaft portion may comprise a first shaft width and the wide shaft portion may comprise a second shaft width larger than the first shaft width. The narrow shaft portion may allow for a smaller distance between a central longitudinal axis of the shaft compared to the wide shaft portion. Therefore, the narrow shaft portion may facilitate arranging the gripper head in the closed position and the wide shaft portion may facilitate arranging the gripper head in the at least one open position.

The first shaft width and the second shaft width may be measured perpendicularly to the axial direction. That is, the first shaft width may refer to a dimension of the shaft measured radially with respect to the axial direction.

The first and the second shaft width may be a first and a second shaft diameter.

When the gripper can be in the closed position each arm pin may contact the shaft at the narrow shaft portion. Thus, the at least one movable arm may be closer to a central longitudinal axis of the shaft.

When the gripper can be in the at least one open position each arm pin may contact the shaft at the wide shaft portion. Thus, the at least one movable arm may be further from a central longitudinal axis of the shaft.

The narrow shaft portion may comprise at least one pin slot configured to receive the at least one arm pin. The pin slot may facilitate generating the holding force, thus arranging the gripper head in a stable position.

The wide shaft portion may comprise at least one pin slot configured to receive the at least one arm pin.

Each pin slot can be configured such that when an arm pin can be received therein, the gripper head and the shaft remain attached to each other.

Each pin slot can be configured such that when an arm pin can be received therein, the relative motion is hindered.

Each pin slot can be configured to allow an arm pin exit the pin slot when a force exceeding a force threshold parallel to the axial direction can be exerted on the arm pin. Therefore, the gripper head can be transitioned out of a stable position. Simply put, the pin slot can be configured such that the arm pin is not indefinitely stuck in the pin slot.

Each pin slot may comprise sloped and/or rounded edges. This can facilitate the arm pin exiting the pin slot.

The gripper may comprise a biasing mechanism configured to exert a force on each movable arm directed towards the shaft. Thus, the movable arms may be biased to remain closed.

The biasing mechanism can be configured to generate at least a portion of the pulling force.

The biasing mechanism may comprise at least one spring configured to exert said force on each movable arm directed towards the shaft.

The gripper may further comprise a locking mechanism. This can facilitate generating the holding force during one or more of the stable positions.

The locking mechanism can be configured to keep the gripper head and the shaft attached to each other during at least some of the stable positions.

The locking mechanism can be configured to keep the gripper head and the shaft attached to each other during the at least one open position.

The locking mechanism can be configured to keep the gripper head and the shaft attached to each other during the closed position.

The locking mechanism may comprise at least one pair of locking components configured to latch together to keep the gripper head and the shaft attached to each other, wherein one of the locking components of the pair can be fixed to the gripper head and the other one can be fixed to the shaft.

Each pair of locking components may comprise a pin and a pin slot.

The gripper may further comprise a stopper configured to remain fixed along the axial direction. The stopper may be particularly advantageous as it may facilitate generating a force that may counteract the holding force. That is, the stopper may facilitate transitioning the gripper head out of one or more of the stable positions.

The stopper may also facilitate close (and thus create) the cycle of transitions between the different stable positions, wherein the gripper head may cyclically transition between different stable positions only via relative motion along the axial direction between the shaft and the gripper head.

The gripper can be configured to utilize the stopper to transition from one stable position to another.

The gripper can be configured to utilize the stopper to transition from the at least one open position to the closed position.

The gripper can be configured to utilize the stopper to separate the proximal housing magnetic element and the shaft magnet.

The stopper can be configured to exert a separation force parallel to the axial direction on an element of the gripper that becomes in contact with the stopper.

The separation force can be parallel and opposite to the holding force.

A maximum of the separation force can be larger than the holding force.

The shaft can be allowed to move along the axial direction with respect to the stopper.

The stopper can be positioned such that it can be closer to the distal housing end than to the proximal housing end.

The stopper can be hollow and the shaft may pass through the stopper.

The stopper and the shaft may be configured to have a clearance fit between them. Thus, the shaft may slide through the sopper un-interfered by the stopper.

The stopper can be configured to limit the range of motion of the gripper head along the axial direction. For example, the housing may be wider than the hollow portion of the stopper. Thus, the housing can be hindered from sliding through the stopper.

The gripper head can be configured to be brought in contact with the stopper via a motion of the gripper along the axial direction towards the stopper while the gripper can be in any stable position.

Motion of the gripper along the axial direction towards the stopper may cause the separation force to be exerted from the stopper to the gripper head. In particular, the shaft may slide through the stopper, while the housing is hindered from doing so, thus generating a separation force along the axial direction which can cause relative motion between the shaft and the gripper head. Said relative motion may transition the stopper out a stable position.

The shaft may comprise a shaft hollow component and a shaft pin, wherein the shaft pin can be inserted through the shaft hollow component and wherein the shaft pin can be allowed to move along the axial direction with respect to the shaft hollow component. This may be particularly advantageous as it may alleviate the need of contact between the gripper head and the stopper. More particularly, the function of the stopper, namely transitioning the gripper from one stable position to another, may be realized by contact between the stopper and the shaft pin. As a result, there may be not need to provide the stopper in proximity to the housing. The stopper may for example be provided near the distal shaft end. This can further reduce the size of the gripper, at least near the contact point.

The shaft pin can be longer than the shaft hollow component. This can allow the shaft pin to exit the shaft hollow component to thereby be able to contact the stopper and the housing.

The gripper can be configured such that the shaft pin can be allowed to contact the proximal bore end.

The shaft magnet can be hollow and wherein the shaft pin can be allowed to move through the shaft magnet.

The stopper can be positioned in a remote location with respect to the gripper head.

The stopper can be positioned near the distal shaft end.

The stopper can be configured to limit the range of motion of the shaft along the axial direction.

The shaft pin can be configured to be brought in contact with the stopper via a motion of the gripper along the axial direction towards the stopper.

Said motion of the gripper along the axial direction towards the stopper may cause the shaft pin to contact the stopper, which in turn may cause the shaft pin to protrude beyond the proximal shaft end.

Said motion of the gripper along the axial direction towards the stopper may cause the separation force to be exerted from the stopper to the shaft pin and from the shaft pin to the gripper head.

The gripper head may comprise an item space configured to be occupied, at least in part, by a portion of the item.

The item space can be partially enclosed by the at least one movable arm.

A dimension of the item space can be dependent upon a motion, e.g., a rotation, of the at least one movable arm.

A dimension of the item space can be larger when the gripper can be in the at least one open position than when the gripper can be in the closed position.

A dimension of the item space can be at maximum when the gripper can be in the at least one open position.

A dimension of the item space when the gripper can be in the closed position can be such that the gripped portion of the item may fit snuggly in the item space.

Said dimension of the item space can be measured perpendicularly to the axial direction.

Each movable arm can be joined to the housing via a respective arm joint.

Each arm joint may comprise at least one degree of freedom.

The gripper head may comprise a plurality of arms.

The gripper head may comprise two arms.

The gripper head may comprise three arms.

The gripper head may comprise four arms.

The item space can be partially enclosed by the arms.

At least one of the arms can be the at least one movable arm.

The arms may be distributed around the shaft.

The arms may be evenly distributed around the shaft, such that the arms may be separated by equal angular spacing.

Two of the arms may be opposing arms positioned in opposite sides of the shaft.

At least one of the opposing arms can be the at least one movable arm.

The gripper head may comprise at least one fixed arm firmly attached to the housing. This may further reduce the number of moving parts comprise by the gripper and as a result improve robustness of the gripper.

At least one of the arms can be the at least one fixed arm.

Each arm can be shaped to allow a positive locking between the gripper and the item. Thus, the gripper may securely hold the item.

Each arm may comprise a latching portion configured to latch into a portion of the item.

Each arm can be configured to allow a frictional locking between the gripper and the item. The frictional locking may be advantageous as it reduces the likelihood of the item getting stuck in the gripper. However, typically frictional locking may reduce the maximum weight of the items that the gripper may carry, at least as compared to a positive locking.

Each arm may comprise a contact edge configured to contact the item.

The contact edge may abut the item space.

The contact edge may comprise a coating with a high friction material. This may increase the hold of the item by the gripper.

The coating may comprise an anisotropic coefficient of friction such that the coefficient of friction can be higher in a direction that separates the item from the gripper than in a direction that joins the item with the gripper. Thus, the item may not slide out of the gripper when being transported by the gripper, while at the same time the gripper may move away from the item during release.

Said anisotropic coefficient of friction can be anisotropic in the axial direction.

The arm may comprise a free end portion which can be a portion of the arm that can be furthest from the housing.

The free end portion may comprise a contact edge configured to contact the item during gripping.

A gap between the contact edge of the free end portion and a central axis of the housing parallel to the axial direction may become narrower from a furthest position to a nearest position within the free end portion with respect to the housing. Thus, the contact edge may align the item and the gripper.

The contact edge of the free end portion can be a sloped edge.

The gripper can be configured to be driven along the axial direction by an actuator.

The gripper can be configured to be driven only along the axial direction by an actuator for the purpose of gripping an item.

The gripper may comprise an actuator configured to drive the shaft along the axial direction.

The gripper may comprise an actuator configured to drive the shaft only along the axial direction for the purpose of gripping an item.

The actuator can be an electromagnetic, pneumatic or hydraulic actuator. It will be understood that these are exemplary.

The gripper may further comprise at least one monitoring sensor. The monitoring sensor may facilitate keeping track of the gripper and in particular of the respective position that the gripper can be in. As such, the gripper may be operated more safely and accurately.

The at least one monitoring sensor can be fixed with respect to the shaft.

The at least one monitoring sensor can be configured to measure a position of the gripper head along the axial direction.

The at least one monitoring sensor can be configured to measure a change in the relative position between the gripper head and the shaft.

The at least one monitoring sensor can be configured to measure a motion, e.g., a rotation, of the at least one movable arm.

The at least one monitoring sensor can be configured to detect presence of the housing at one or more positions along the axial direction.

The at least one monitoring sensor may comprise an optical sensor.

The at least one monitoring sensor may comprise at least one reflex light barrier sensor. The reflex light barrier sensor may comprise a light emitter (e.g., an LED) and a light receiver (e.g., a phototransistor). The housing may comprise a varying width which is measured perpendicularly to the axial direction and which varies along the axial direction. For example, the housing or a portion thereof may comprise a conical shape. The varying width of the housing affects the detected light by the reflex light barrier sensor. Thus, there can be a relationship, preferably a one-to-one relationship, between the varying width and the detected light by the reflex light barrier sensor. Said relationship may be used to determine the position of the housing. Alternatively or additionally, a coating may be provided on the housing said coating comprising a varying degree of reflection along the axial direction. This can also be used to determine the position of the housing based on the detected light by the reflex light barrier sensor.

The at least one monitoring sensor may comprise a magnetic sensor configured to measure a strength and/or orientation of a magnetic field.

The at least one monitoring sensor may comprise a sensor disk mounted on the shaft.

The shaft may comprise at least one marker for facilitating a measurement of position of the shaft along the axial direction.

The at least one monitoring sensor can be configured such that its output can be indicative of an accidental relative motion between the shaft and the housing.

The gripper may comprise an arm motion limiter configured to set a limit, preferably selectively, on the range of motion of the at least one movable arm. Thus, the range of motion can be controller which can decrease the likelihood of the at least one moveable arm colliding with other elements, e.g., with other items to be gripped. Moreover, being able to selectively set the limit can be advantageous as it can allow adapting the gripper to the particular item(s) being gripped.

The gripper can be configured to move the item along the axial direction.

The item can be a sample container.

The sample container may comprise a lid.

The gripper can be configured to grip the item by the lid.

The gripper can be configured to grip the sample container such that the axial direction can be parallel with a central axis of the sample container extending from the lid to a bottom of the sample container.

The gripper head can be configured to be mounted to the shaft via the relative motion. That is, the same motion requirements needed to move the at least one moveable arm may also be sufficient for mounting the gripper head and the shaft together. This may facilitate streamlining operation of the gripper, including mounting its gripper head.

The gripper head can be configured to be mounted to the shaft by inserting the shaft in the housing bore of the gripper head.

The gripper head can be configured to be removable from the shaft. Being able to remove the gripper head may facilitate replacing it. In turn, this may make it easier to repair the gripper and/or adapt the gripper to be able to grip different items.

The gripper head can be configured to be removable from the shaft via the relative motion. That is, the same motion requirements needed to move the at least one moveable arm may also be sufficient for removing the gripper head from the shaft. This may facilitate streamlining operation of the gripper, including removing its gripper head.

The gripper head can be configured to be removable from the shaft by removing the shaft out of the housing bore via the relative motion.

The shaft can be configured to exit the housing bore from the distal bore end.

At least one arm joint can be a rotational joint and wherein at least one moveable arm can be a rotatable arm, wherein each rotatable arm can be rotatably joined to the housing via a respective rotational joint. Movement of each rotatable arm may thus include rotation, i.e., pivoting, of the rotatable arm around the rotational joint.

At least one rotational joint may comprise an arm axle. Each rotatable arm may pivot around the respective arm axle.

Each rotational joint may comprise at least one angular degree of freedom.

At least one rotational joint can be a flexure joint. Each flexure joint may be flexible, the flexibility of which may allow rotation of a respective one of the at least one rotational arm.

The housing and each rotatable arm that can be joined to the housing via a respective flexure joint may be made of a single part.

At least one arm joint can be a translational joint and wherein at least one moveable arm can be a translatable arm, wherein each translatable arm can be joined to the housing via a respective translational joint such that each translatable arm can be movable in a radial direction, wherein the radial direction can be perpendicular to the axial direction. For example, the translational joint may comprise a pick and rack mechanism.

The gripper head can be mounted on the shaft such that rotation of the shaft about the axial direction may cause rotation of the gripper head about the axial direction. This can be implemented via interlocking parts provided in the gripper head and the shaft configured to allow relative motion along the axial direction and hinder rotational motion around an axis parallel to the axial direction. For example, this can be implemented with a ridge and groove mechanism, wherein a ridge can be provided on one of the shaft or the gripper head and the groove can be provided on the other. The ridge and the groove can be parallel to the axial direction. Moreover, the ridge can be configured to slide in the groove along the axial direction.

The gripper head can be rotationally locked with the shaft.

Wherein the gripper head can be mounted on the shaft such that rotational motion about the axial direction of the gripper head relative to the shaft can be prevented.

The present invention further relates to a system comprising at least one item, the gripper and wherein the gripper is configured to grip the at least one item.

The gripper may comprise any of the features discussed above and below in relation thereto.

The system can further comprise an actuator configured to actuate the gripper along the axial direction.

Each item can be a sample container.

The sample container may comprise a lid.

The gripper can be configured to grip the item by the lid.

The gripper can be configured to grip the sample container such that the axial direction can be parallel with a central axis of the sample container extending from the lid to a bottom of the sample container.

The system can further comprise an analytical device configured to analyze a liquid.

The analytical device can be a chromatography device.

The analytical device can be a liquid chromatography device.

The analytical device can be a high-performance liquid chromatography device.

The system can further comprise an item identification system and wherein the gripper can be part of the item identification system.

Each item may comprise a label and wherein the item identification system can be configured to identify each item by sensing the respective label.

The system can further comprise an item tray configured to contain a plurality of items and containing the at least one item.

The gripper can be configured to move each item along the axial direction.

The system may further comprise a replacement gripper head for replacing the gripper head of the gripper.

The replacement gripper head can be identical to the gripper head.

The replacement gripper head can be configured to grip items with a different shape and/or size compared to the gripper head.

The replacement gripper head can be configured to be mounted to the shaft, after removing the gripper head from the shaft, via a motion of the shaft along the axial direction.

The system may further comprise a positioning system configured to move the gripper along at least one direction that can be different from the axial direction.

The present invention can further relate to a use of the gripper to grip an item.

The present invention can further relate to a use of the gripper to grip and move an item.

The present invention can further relate to a use of the gripper to grip, move and rotate an item

The present invention can further relate to a use of the gripper in a chromatography system.

The present invention can further relate to a use of the gripper in a chromatography system to grip and move a sample container containing a liquid to be analyzed.

The chromatography system can be a liquid chromatography system.

The chromatography system can be a high-performance liquid chromatography system.

The item can be a sample container.

The present invention further relates to a method comprising gripping an item with the gripper.

The gripper may comprise any of the features discussed above and below in relation thereto.

Gripping the item may comprise actuating the gripper along the axial direction towards the item.

Gripping the item may comprise actuating the gripper along the axial direction towards the item until the item can be positioned in the item space of the gripper.

The method may comprise keeping the gripper in the closed position prior to and while gripping the item.

The method may comprise keeping the gripper in the at least one open position prior to gripping the item.

The at least one open position can be the distal open position.

Gripping the item may comprise transitioning the gripper from the at least one open position to the closed position by causing the relative motion between the shaft and the gripper head.

Transitioning the gripper from the at least one open position to the closed position may comprise actuating the gripper along the axial direction.

Transitioning the gripper from the at least one open position to the closed position may comprise actuating the gripper along the axial direction towards the item after the gripper head contacts the item.

The item may rest on an origin support structure prior to being gripped.

The method may comprise lifting the item with the gripper by driving the gripper along the axial direction, after gripping the item.

The method may comprise maintaining the gripper in the closed position while lifting the item.

The method may comprise, after lifting the item with the gripper, placing the item on a destination support structure by driving the gripper along the axial direction.

The method may comprise keeping the gripper in the closed position while placing the item on the destination support structure.

The origin support structure and the destination support structure may be the same.

The method may comprise releasing the item from the gripper.

Releasing the item from the gripper may comprise transitioning the gripper from the closed position to the at least one open position by causing the relative motion between the shaft and the gripper head.

The at least one open position can be the proximal open position.

Transitioning the gripper from the closed position to the at least one open position may comprise actuating the gripper along the axial direction.

Transitioning the gripper from the closed position to the at least one open position may comprise actuating the gripper along the axial direction towards the item, while the item rests on a support structure.

The method may comprise transitioning the gripper from the at least one open position to the closed position by driving the gripper along the axial direction such that the gripper head abuts the stopper.

The method may comprise transitioning the gripper from the proximal open position to the distal open position by driving the gripper along the axial direction such that the gripper head abuts the stopper.

The method may comprise mounting the gripper head to the shaft by driving the shaft along the axial direction towards the housing such that the shaft can be inserted in the housing bore.

The method may comprise separating the gripper head from the shaft by driving the shaft along the axial direction away from the housing such that the shaft may exit the housing bore.

The method may comprise replacing the gripper head by separating a mounted gripper head from the shaft by driving the shaft along the axial direction away from the housing of the mounted gripper head such that the shaft may exit the housing bore of the mounted gripper head and mounting a new gripper head to the shaft by driving the shaft along the axial direction towards the housing of the new gripper head such that the shaft can be inserted in the housing bore.

The method may comprise rotating the shaft of the gripper around a rotational axis being parallel to the axial direction and wherein rotation of the shaft causes rotation of the gripper head around said rotational axis.

The method may comprise rotating the gripper head around the rotational axis to align the so that arms of the gripper fit in the space around the item.

The method may comprise prior to gripping the item aligning the gripper with the item using a positioning system configured to move the gripper along at least one direction that can be different from the axial direction.

The method may comprise prior to placing the item with the gripper on a destination support structure aligning the gripper with the destination support structure using a positioning system configured to move the gripper along at least one direction that can be different from the axial direction.

The method may comprise prior to mounting the new gripper head aligning the shaft with the housing bore of the new gripper head using a positioning system configured to move the gripper along at least one direction that can be different from the axial direction.

The gripper can be configured to carry out the method, as discussed above and below.

The system can be configured to carry out the method, as discussed above and below.

Generally, it will thus be understood that embodiments of the present invention reduce the number of active components. The functions of gripping, releasing and closing can be actuated only by movements along a single direction (below referred to as axial direction). The movement and force exerted by the gripper arms can be effected by permanent magnets, whose respective situation-dependent position can cause an attracting or repelling force. This can result in bistable (open/closed) and resilient (gripping) behavior.

The present invention further relates to the following numbered embodiments.

Below, device embodiments will be discussed. These embodiments are abbreviated by the letter “D” followed by a number. When reference is herein made to device embodiments, these embodiments are meant.

D1. A gripper (10) for gripping an item (7) comprising:
a shaft (4) extending longitudinally along an axial direction;
a gripper head (9) mounted on the shaft (4) such that it is allowed to slide along the axial direction with respect to the shaft (4);
wherein the gripper head (9) comprises:
   a housing (2); and
   at least one movable arm (12), wherein each movable arm (12) is moveable relative to the housing (2);
wherein a relative motion along the axial direction between the shaft (4) and the gripper head (9) causes the at least one movable arm (12) to move.

D2. The gripper (10) according to the preceding embodiment, wherein the housing (2) comprises a housing bore (21) configured to receive the shaft (4).

D3. The gripper (10) according to the preceding embodiment, wherein the housing bore (21) comprises a bore axis parallel to the axial direction.

D4. The gripper (10) according to any of the 2 preceding embodiments, wherein the housing bore (21) is centrally located in the housing (2).

D5. The gripper (10) according to any of the 3 preceding embodiments, wherein the housing bore (21) comprises a proximal bore end (22) and a distal bore end (23), wherein the shaft (4) is inserted in the housing bore (21) from the distal bore end (23) towards the proximal bore end (22).

D6. The gripper (10) according to any of the 4 preceding embodiments, wherein the housing bore (21) and the shaft (4) are configured to allow a clearance fit between each other.

D7. The gripper (10) according to any of the 5 preceding embodiments, wherein the relative motion comprises sliding of the shaft (4) in the housing bore (21).

D8. The gripper (10) according to any of the preceding embodiments, wherein the housing (2) comprises a proximal housing end (24) and a distal housing end (25), wherein the shaft (4) is inserted in the housing (2) from the distal housing end (25) towards the proximal housing end (24).

D9. The gripper (10) according to any of the preceding embodiments, wherein the relative motion arranges the gripper head (9) in different relative positions with respect to the shaft (4).

D10. The gripper (10) according to the preceding embodiment, wherein some of the relative positions are stable positions, wherein in each stable position a holding force keeps the gripper head (9) and the shaft (4) fixed to each other.

D11. The gripper (10) according to the preceding embodiment, wherein the holding force hinders relative motion along the axial direction between the gripper head (9) and the shaft (4), while the gripper (10) is in each of the stable positions.

D12. The gripper (10) according to any of the 2 preceding embodiments, wherein the stable positions comprise at least one open position (101) and a closed position (105).

D13. The gripper (10) according to the preceding embodiment, wherein one of the at least one open position (101) is a proximal open position (102).

D14. The gripper (10) according to the preceding embodiment and with the features of embodiment D2, wherein the shaft (4) is inserted further into the housing bore (21) when the gripper (10) is in the proximal open position (102) than when the gripper (10) is in the closed position (105).

D15. The gripper (10) according to any of the 2 preceding embodiments and with the features of embodiment D2, wherein the shaft (4) is inserted most into the housing bore (21) when the gripper (10) is in the proximal open position (102).

D16. The gripper (10) according to any of the 4 preceding embodiments, wherein one of the at least one open position (101) is a distal open position (103).

D17. The gripper (10) according to the preceding embodiment and with the features of embodiment D2, wherein the shaft (4) is inserted further into the housing bore (21) when the gripper (10) is in the closed position (105) than when the gripper (10) is in the distal open position (103).

D18. The gripper (10) according to any of the 2 preceding embodiments and with the features of embodiment D13, wherein the shaft (4) is inserted further into the housing bore (21) when the gripper (10) is in the proximal open position (102) than when the gripper (10) is in the distal open position (103).

D19. The gripper (10) according to any of the 7 preceding embodiments, wherein in each of the at least one open position (101), the at least one movable arm (12) is positioned to allow release of the item (7), and in the closed position (105), the at least one movable arm (12) is positioned to grip the item (7).

D20. The gripper (10) according to any of the 8 preceding embodiments, wherein in each of the least one open position (101) a pushing force pushes the at least one movable arm (12) away from the shaft (4).

D21. The gripper (10) according to the preceding embodiment, wherein a magnitude of the pushing force depends on the position of the gripper head (9) along the axial direction with respect to the shaft (4).

D22. The gripper (10) according to any of the 10 preceding embodiments, wherein in the closed position (105) a pulling force pulls the at least one movable arm (12) towards the shaft (4).

D23. The gripper (10) according to the preceding embodiment, wherein a magnitude of the pulling force depends on the position of the gripper head (9) along the axial direction with respect to the shaft (4).

D24. The gripper (10) according to any of the preceding embodiments and with the features of embodiments D20 and D22, wherein when the gripper (10) is in the at least one open position (101) the pushing force is larger than the pulling force.

D25. The gripper (10) according to any of the preceding embodiments and with the features of embodiments D20 and D22, wherein when the gripper (10) is in the closed position (105) the pulling force is larger than the pushing force.

D26. The gripper (10) according to any of the preceding embodiments, wherein the shaft (4) comprises a proximal shaft end (41) configured to be inserted in the housing (2).

D27. The gripper (10) according to the preceding embodiment, wherein the shaft (4) comprises a distal shaft end (42) opposite the proximal shaft end (41).

D28. The gripper (10) according to the 2 preceding embodiments, wherein the shaft (4) extends longitudinally from the proximal shaft end (41) to the distal shaft end (42).

D29. The gripper (10) according to any of the preceding embodiments, wherein the shaft (4) comprises a shaft magnet (45) firmly attached to the shaft (4).

D30. The gripper (10) according to the preceding embodiment, wherein the shaft magnet (45) is a permanent magnet.

D31. The gripper (10) according to any of the 2 preceding embodiments and with the features of embodiment D26, wherein the shaft magnet (45) is positioned near or at the proximal shaft end (41).

D32. The gripper (10) according to any of the 3 preceding embodiments, wherein the shaft magnet (45) comprises a proximal shaft magnetic pole (46) and a distal shaft magnetic pole (47) which are arranged along the axial direction and comprise opposite polarities.

D33. The gripper (10) according to the preceding embodiment and with the features of embodiment D26, wherein the proximal shaft magnetic pole (46) is closer to the proximal shaft end (41) than the distal shaft magnetic pole (47).

D34. The gripper (10) according to any of the preceding embodiments, wherein each movable arm (12) comprises a joint arm end (11) and a free arm end (13).

D35. The gripper (10) according to the preceding embodiment, wherein the joint arm end (11) is inside the housing (2) and the free arm end (13) is outside the housing (2).

D36. The gripper (10) according to any of the 2 preceding embodiments, wherein each movable arm (12) extends longitudinally from the joint arm end (11) to the free arm end (13).

D37. The gripper (10) according to any of the 3 preceding embodiments, wherein at least one movable arm (12) is rotatably mounted to the housing (2) at or near the joint arm end (11).

D38. The gripper (10) according to any of the preceding embodiments, further comprising at least one arm magnet (15) firmly attached to a respective one of the at least one movable arm (12).

D39. The gripper (10) according to the preceding embodiment, wherein each arm magnet (15) is a permanent magnet.

D40. The gripper (10) according to any of the 2 preceding embodiments, wherein each arm magnet (15) comprises the same or similar position along the axial direction.

D41. The gripper (10) according to any of the 3 preceding embodiments and with the features of embodiments D12 and D29, wherein the shaft magnet (45) and the at least one arm magnet (15) are arranged such that
in each of the at least one open position (101) there is a dominant magnetic repulsion force between the shaft magnet (45) and each of the at least one arm magnet (15) and
in the closed position (105) there is a dominant magnetic attraction force between the shaft magnet (45) and each of the at least one arm magnet (15).

D42. The gripper (10) according to any of the 4 preceding embodiments and with the features of embodiments D12 and D29, wherein the shaft magnet (45) and the at least one arm magnet (15) are arranged such that
in each of the at least one open position (101) at least one magnetic pole of the shaft magnet (45) comprises the same or similar position along the axial direction with a same magnetic pole of each arm magnet (15) and
in the closed position (105) at least one magnetic pole of the shaft magnet (45) comprises the same or similar position along the axial direction with an opposite magnetic pole of each arm magnet (15).

D43. The gripper (10) according to any of the 5 preceding embodiments and with the features of embodiment D29, wherein the shaft magnet (45) and the at least one arm magnet (15) are arranged such that the shaft magnet (45) comprises a reverse magnetic orientation with each of the at least one arm magnet (15).

D44. The gripper (10) according to any of the 6 preceding embodiments and with the features of embodiments D20 and D29, wherein the pushing force comprises a magnetic repulsion force between the shaft magnet (45) and each of the at least one arm magnet (15).

D45. The gripper (10) according to any of the 7 preceding embodiments and with the features of embodiments D22 and D29, wherein the pulling force comprises a magnetic attraction force between the shaft magnet (45) and the at least one arm magnet (15).

D46. The gripper (10) according to any of the 8 preceding embodiments and with the features of embodiments D12 and D29, wherein the holding force, while the gripper (10) is in the closed position (105), comprises a magnetic attraction force between the shaft magnet (45) and the at least one arm magnet (15).

D47. The gripper (10) according to any of the 9 preceding embodiments, wherein each arm magnet (15) comprises a proximal arm magnetic pole (16) and a distal arm magnetic pole (17) which are arranged along a longitudinal direction of the respective arm and comprise opposite polarities.

D48. The gripper (10) according to the preceding embodiment, wherein the proximal arm magnetic pole (16) is of the same polarity for each arm magnet (15) and the distal arm magnetic pole (17) is of the same polarity for each arm magnet (15).

D49. The gripper (10) according to any of the 2 preceding embodiments and with the features of embodiment D34, wherein the proximal arm magnetic pole (16) is closer to the free arm end (13) than the distal arm magnetic pole (17).

D50. The gripper (10) according to any of the 3 preceding embodiments and with the features of embodiment D32, wherein the distal shaft magnetic pole (47) and the distal arm magnetic pole (17) of each arm magnet (15) comprise opposite polarities.

D51. The gripper (10) according to any of the 4 preceding embodiments and with the features of embodiment D32, wherein the proximal shaft magnetic pole (46) and the proximal arm magnetic pole (16) of each arm magnet (15) comprise opposite polarities.

D52. The gripper (10) according to any of the preceding embodiments, wherein the housing (2) comprises a proximal housing magnetic element (26).

D53. The gripper (10) according to the preceding embodiment, wherein the proximal housing magnetic element (26) comprises a material that is attractable by a magnetic field.

D54. The gripper (10) according to any of the 2 preceding embodiments and with the features of embodiment D2, wherein the proximal housing magnetic element (26) is positioned inside the housing bore (21).

D55. The gripper (10) according to any of the 3 preceding embodiments and with the features of embodiment D5, wherein the proximal housing magnetic element (26) is positioned near or at the proximal bore end (22).

D56. The gripper (10) according to any of the 4 preceding embodiments and with the features of embodiments D8 and D38, wherein the proximal housing magnetic element (26) is closer to the proximal housing end (24) than each arm magnet (15).

D57. The gripper (10) according to any of the 5 preceding embodiments and with the features of embodiment D13, wherein a distance between the proximal housing magnetic element (26) and the shaft magnet (45) is at minimum while the gripper (10) is in the proximal open position (102).

D58. The gripper (10) according to any of the 6 preceding embodiments and with the features of embodiment D13, wherein the proximal housing magnetic element (26) and the shaft magnet (45) are magnetically attached to each other while the gripper (10) is in the proximal open position (102).

D59. The gripper (10) according to any of the 7 preceding embodiments and with the features of embodiment D29, wherein the shaft magnet (45) and the proximal housing magnetic element (26) are configured such that there is a magnetic attraction force between the shaft magnet (45) and the proximal housing magnetic element (26).

D60. The gripper (10) according to the preceding embodiment, wherein said magnetic attraction force between the shaft magnet (45) and the proximal housing magnetic element (26) is along the axial direction.

D61. The gripper (10) according to any of the 2 preceding embodiments and with the features of embodiment D12, wherein while the gripper (10) is in the closed position (105) said magnetic attraction force between the shaft magnet (45) and the proximal housing magnetic element (26) is smaller than a force required to generate the relative motion between the gripper head (9) and the shaft (4).

D62. The gripper (10) according to any of the 3 preceding embodiments and with the features of embodiment D13, wherein the holding force, while the gripper (10) is in the proximal open position (102), comprises said magnetic attraction force between the shaft magnet (45) and the proximal housing magnetic element (26).

D63. The gripper (10) according to any of the 11 preceding embodiments, wherein the proximal housing magnetic element (26) comprises a proximal ferromagnetic element.

D64. The gripper (10) according to any of the 12 preceding embodiments, wherein the proximal housing magnetic element (26) comprises a proximal housing magnet.

D65. The gripper (10) according to the preceding embodiment, wherein the proximal housing magnet is a permanent magnet.

D66. The gripper (10) according to any of the 2 preceding embodiments, wherein the magnetic poles of the proximal housing magnet are arranged along the axial direction.

D67. The gripper (10) according to any of the 3 preceding embodiments and with the features of embodiment D29, wherein the proximal housing magnet and the shaft magnet (45) are arranged such that they comprise the same magnetic orientation.

D68. The gripper (10) according to any of the 4 preceding embodiments and with the features of embodiment D38, wherein the proximal housing magnet and the at least one arm magnet (15) are arranged such that the proximal housing magnet comprises a reverse magnetic orientation with each of the at least one arm magnet (15).

D69. The gripper (10) according to any of the preceding embodiments, wherein the housing (2) comprises a distal housing magnetic element (27).

D70. The gripper (10) according to the preceding embodiment, wherein the distal housing magnetic element (27) comprises a material that is attractable by a magnetic field.

D71. The gripper (10) according to any of the 2 preceding embodiments and with the features of embodiments D8 and D38, wherein the distal housing magnetic element (27) is closer to the distal housing end (25) than each arm magnet (15).

D72. The gripper (10) according to any of the 3 preceding embodiments and with the features of embodiment D38 and D52, wherein each arm magnet (15) is positioned along the axial direction between the distal housing magnetic element (27) and the proximal housing magnetic element (26).

D73. The gripper (10) according to any of the 4 preceding embodiments and with the features of embodiment D16 and D29, wherein a distance between the distal housing magnetic element (27) and the shaft magnet (45) is at minimum while the gripper (10) is in the distal open position (103).

D74. The gripper (10) according to any of the 5 preceding embodiments and with the features of embodiment D29, wherein the shaft magnet (45) and the distal housing magnetic element (27) are configured such that there is a magnetic attraction force between the shaft magnet (45) and the distal housing magnetic element (27).

D75. The gripper (10) according to the preceding embodiment, wherein said magnetic attraction force between the shaft magnet (45) and the distal housing magnetic element (27) comprises a force component that is perpendicular to the axial direction.

D76. The gripper (10) according to any of the 2 preceding embodiments and with the features of embodiment D12, wherein while the gripper (10) is in the closed position (105) said magnetic attraction force between the shaft magnet (45) and the distal housing magnetic element (27) is smaller than a force required to generate a relative motion between the gripper head (9) and the shaft (4).

D77. The gripper (10) according to any of the 3 preceding embodiments and with the features of embodiment D16, wherein the holding force, while the gripper (10) is in the distal open position (103), comprises said magnetic attraction force between the shaft magnet (45) and the distal housing magnetic element (27).

D78. The gripper (10) according to any of the 9 preceding embodiments, wherein the distal housing magnetic element (27) comprises a distal ferromagnetic element.

D79. The gripper (10) according to any of the 10 preceding embodiments, wherein the distal housing magnetic element (27) comprises a distal housing magnet.

D80. The gripper (10) according to the preceding embodiment, wherein the distal housing magnet is a permanent magnet.

D81. The gripper (10) according to any of the 2 preceding embodiments, wherein the magnetic poles of the distal housing magnet are arranged along the axial direction.

D82. The gripper (10) according to any of the 3 preceding embodiments and with the features of embodiment D29, wherein the distal housing magnet and the shaft magnet (45) are arranged such that they comprise the same magnetic orientation.

D83. The gripper (10) according to any of the 4 preceding embodiments and with the features of embodiment D64, wherein the distal housing magnet and the proximal housing magnet are arranged such that they comprise the same magnetic orientation.

D84. The gripper (10) according to any of the 5 preceding embodiments and with the features of embodiment D38, wherein the distal housing magnet and the at least one arm magnet (15) are arranged such that the distal housing magnet comprises a reverse magnetic orientation with each of the at least one arm magnet (15).

D85. The gripper (10) according to any of the preceding embodiments, further comprising at least one arm pin (93), wherein each arm pin (93) is attached to a respective movable arm (12) and protrudes from the respective movable arm (12) towards the shaft (4).

D86. The gripper (10) according to the preceding embodiment, wherein each arm pin (93) is configured to contact the shaft (4).

D87. The gripper (10) according to any of the 2 preceding embodiments, wherein the shaft (4) comprises a narrow shaft portion (48) and a wide shaft portion (49) comprising different positions along the axial direction and wherein
the narrow shaft portion (48) comprises a first shaft width,
the wide shaft portion (49) comprises a second shaft width larger than the first shaft width.

D88. The gripper (10) according to the preceding embodiment, wherein the first shaft width and the second shaft width are measured perpendicularly to the axial direction.

D89. The gripper (10) according to any of the 2 preceding embodiments, wherein the first and the second shaft width are a first and a second shaft diameter.

D90. The gripper (10) according to any of the 5 preceding embodiments and with the features of embodiment D12, wherein when the gripper (10) is in the closed position (105) each arm pin (93) contacts the shaft (4) at the narrow shaft portion (48).

D91. The gripper (10) according to any of the 6 preceding embodiments and with the features of embodiment D12, wherein when the gripper (10) is in the at least one open position (101) each arm pin (93) contacts the shaft (4) at the wide shaft portion (49).

D92. The gripper (10) according to any of the 7 preceding embodiments, wherein the narrow shaft portion (48) comprises at least one pin slot (96) configured to receive the at least one arm pin (93).

D93. The gripper (10) according to any of the 8 preceding embodiments, wherein the wide shaft portion (49) comprises at least one pin slot (96) configured to receive the at least one arm pin (93).

D94. The gripper (10) according to any of the 2 preceding embodiments, wherein each pin slot (96) is configured such that when an arm pin (93) is received therein, the gripper head (9) and the shaft (4) remain attached to each other.

D95. The gripper (10) according to any of the 3 preceding embodiments, wherein each pin slot (96) is configured such that when an arm pin (93) is received therein, the relative motion is hindered.

D96. The gripper (10) according to any of the 4 preceding embodiments, wherein each pin slot (96) is configured to allow an arm pin (93) exit the pin slot (96) when a force exceeding a force threshold parallel to the axial direction is exerted on the arm pin (93).

D97. The gripper (10) according to any of the 5 preceding embodiments, wherein each pin slot (96) comprises sloped and/or rounded edges.

D98. The gripper (10) according to any of the preceding embodiments, comprising a biasing mechanism (92) configured to exert a force on each movable arm (12) directed towards the shaft (4).

D99. The gripper (10) according to the preceding embodiment and with the features of embodiment D22, wherein the biasing mechanism (92) is configured to generate at least a portion of the pulling force.

D100. The gripper (10) according to any of the 2 preceding embodiments, wherein the biasing mechanism (92) comprises at least one spring configured to exert said force on each movable arm (12) directed towards the shaft (4).

D101. The gripper (10) according to any of the preceding embodiments, further comprising a locking mechanism.

D102. The gripper (10) according to the preceding embodiment and with the features of embodiment D10, wherein the locking mechanism is configured to keep the gripper head (9) and the shaft (4) attached to each other during at least some of the stable positions.

D103. The gripper (10) according to any of the 2 preceding embodiments and with the features of embodiment D12, wherein the locking mechanism is configured to keep the gripper head (9) and the shaft (4) attached to each other during the at least one open position (101).

D104. The gripper (10) according to any of the 3 preceding embodiments and with the features of embodiment D12, wherein the locking mechanism is configured to keep the gripper head (9) and the shaft (4) attached to each other during the closed position (105).

D105. The gripper (10) according to any of the 3 preceding embodiments and with the features of embodiment D12, wherein the locking mechanism comprises at least one pair of locking components configured to latch together to keep the gripper head (9) and the shaft (4) attached to each other, wherein one of the locking components of the pair is fixed to the gripper head (9) and the other one is fixed to the shaft (4).

D106. The gripper (10) according to the preceding embodiment, wherein each pair of locking components comprises a pin and a pin slot.

D107. The gripper (10) according to any of the preceding embodiments, further comprising a stopper (5) configured to remain fixed along the axial direction.

D108. The gripper (10) according to the preceding embodiment and with the features of embodiment D10, wherein the gripper (10) is configured to utilize the stopper (5) to transition from one stable position to another.

D109. The gripper (10) according to any of the 2 preceding embodiments and with the features of embodiment D12, wherein the gripper (10) is configured to utilize the stopper (5) to transition from the at least one open position (101) to the closed position (105).

D110. The gripper (10) according to any of the 3 preceding embodiments and with the features of embodiment D58, wherein the gripper (10) is configured to utilize the stopper (5) to separate the proximal housing magnetic element (26) and the shaft magnet (45).

D111. The gripper (10) according to any of the 4 preceding embodiments, wherein the stopper (5) is configured to exert a separation force parallel to the axial direction on an element of the gripper (10) that becomes in contact with the stopper (5).

D112. The gripper (10) according to the preceding embodiment and with the features of embodiment D10, wherein the separation force is parallel and opposite to the holding force.

D113. The gripper (10) according to any of the 2 preceding embodiments and with the features of embodiment D10, wherein a maximum of the separation force is larger than the holding force.

D114. The gripper (10) according to any of the 7 preceding embodiments, wherein the shaft (4) is allowed to move along the axial direction with respect to the stopper (5).

D115. The gripper (10) according to any of the 8 preceding embodiments and with the features of embodiment D8, wherein the stopper (5) is positioned such that it is closer to the distal housing end (25) than to the proximal housing end (24).

D116. The gripper (10) according to any of the preceding embodiments and with the features of embodiment D107, wherein the stopper (5) is hollow and wherein the shaft (4) passes through the stopper (5).

D117. The gripper (10) according to the preceding embodiment, wherein the stopper (5) and the shaft (4) are configured to have a clearance fit between them.

D118. The gripper (10) according to any of the 2 preceding embodiments, wherein the stopper (5) is configured to limit the range of motion of the gripper head (9) along the axial direction.

D119. The gripper (10) according to any of the 3 preceding embodiments and with the features of embodiment D10, wherein the gripper head (9) is configured to be brought in contact with the stopper (5) via a motion of the gripper (10) along the axial direction towards the stopper (5) while the gripper (10) is in any stable position.

D120. The gripper (10) according to the preceding embodiment and with the features of embodiment D111, wherein motion of the gripper (10) along the axial direction towards the stopper (5) causes the separation force to be exerted from the stopper (5) to the gripper head (9).

D121. The gripper (10) according to any of the preceding embodiments and with the features of embodiment D107, wherein the shaft (4) comprises a shaft hollow component (43) and a shaft pin (44), wherein the shaft pin (44) is inserted through the shaft hollow component (43) and wherein the shaft pin (44) is allowed to move along the axial direction with respect to the shaft hollow component (43).

D122. The gripper (10) according to the preceding embodiment, wherein the shaft pin (44) is longer than the shaft hollow component (43).

D123. The gripper (10) according to any of the 2 preceding embodiments and with the features of embodiment D5, wherein the gripper (10) is configured such that the shaft pin (44) is allowed to contact the proximal bore end (22).

D124. The gripper (10) according to any of the 3 preceding embodiments and with the features of embodiment D29, wherein the shaft magnet (45) is hollow and wherein the shaft pin (44) is allowed to move through the shaft magnet (45).

D125. The gripper (10) according to any of the 4 preceding embodiments, wherein the stopper (5) is positioned in a remote location with respect to the gripper head (9).

D126. The gripper (10) according to any of the 5 preceding embodiments and with the features of embodiment D27, wherein the stopper (5) is positioned near the distal shaft end (42).

D127. The gripper (10) according to any of the 6 preceding embodiments, wherein the stopper (5) is configured to limit the range of motion of the shaft (4) along the axial direction.

D128. The gripper (10) according to any of the 7 preceding embodiments, wherein the shaft pin (44) is configured to be brought in contact with the stopper (5) via a motion of the gripper (10) along the axial direction towards the stopper (5).

D129. The gripper (10) according to the preceding embodiment and with the features of embodiment D26, wherein said motion of the gripper (10) along the axial direction towards the stopper (5) causes the shaft pin (44) to contact the stopper (5), which in turn causes the shaft pin (44) to protrude beyond the proximal shaft end (41).

D130. The gripper (10) according to any of the 2 preceding embodiments and with the features of embodiment D111, wherein said motion of the gripper (10) along the axial direction towards the stopper (5) causes the separation force to be exerted from the stopper (5) to the shaft pin (44) and from the shaft pin (44) to the gripper head (9).

D131. The gripper (10) according to any of the preceding embodiments, wherein the gripper head (9) comprises an item space (8) configured to be occupied, at least in part, by a portion of the item (7).

D132. The gripper (10) according to the preceding embodiment, wherein the item space (8) is partially enclosed by the at least one movable arm (12).

D133. The gripper (10) according to any of the 2 preceding embodiments, wherein a dimension of the item space (8) is dependent upon a motion, e.g., a rotation, of the at least one movable arm (12).

D134. The gripper (10) according to any of the 3 preceding embodiments and with the features of embodiment D12, wherein a dimension of the item space (8) is larger when the gripper (10) is in the at least one open position (101) than when the gripper (10) is in the closed position (105).

D135. The gripper (10) according to any of the 4 preceding embodiments and with the features of embodiment D12, wherein a dimension of the item space (8) is at maximum when the gripper (10) is in the at least one open position (101).

D136. The gripper (10) according to any of the 5 preceding embodiments and with the features of embodiment D12, wherein a dimension of the item space (8) when the gripper (10) is in the closed position (105) is such that the gripped portion of the item (7) fits snuggly in the item space (8).

D137. The gripper (10) according to any of the 4 preceding embodiments, wherein said dimension of the item space (8) is measured perpendicularly to the axial direction.

D138. The gripper (10) according to any of the preceding embodiments, wherein each movable arm (12) is joined to the housing (2) via a respective arm joint (30).

D139. The gripper (10) according to the preceding embodiment, wherein each arm joint (30) comprises at least one degree of freedom.

D140. The gripper (10) according to any of the preceding embodiments, wherein the gripper head (9) comprises a plurality of arms.

D141. The gripper (10) according to any of the preceding embodiments, wherein the gripper head (9) comprises two arms.

D142. The gripper (10) according to any of the preceding embodiments, wherein the gripper head (9) comprises three arms.

D143. The gripper (10) according to any of the preceding embodiments, wherein the gripper head (9) comprises four arms.

D144. The gripper (10) according to any of the 4 preceding embodiments and with the features of embodiment D131, wherein the item space (8) is partially enclosed by the arms.

D145. The gripper (10) according to any of the 5 preceding embodiments, wherein at least one of the arms is the at least one movable arm (12).

D146. The gripper (10) according to any of the 6 preceding embodiments, wherein the arms are distributed around the shaft (4).

D147. The gripper (10) according to any of the 7 preceding embodiments, wherein the arms are evenly distributed around the shaft (4), such that the arms are separated by equal angular spacing.

D148. The gripper (10) according to any of the 8 preceding embodiments, wherein two of the arms are opposing arms positioned in opposite sides of the shaft (4).

D149. The gripper (10) according to any of the 9 preceding embodiments, wherein at least one of the opposing arms is the at least one movable arm (12).

D150. The gripper (10) according to any of the preceding embodiments, wherein the gripper head (9) comprises at least one fixed arm firmly attached to the housing (2).

D151. The gripper (10) according to the preceding embodiment and with the features of any of embodiments D140 to D143, wherein at least one of the arms is the at least one fixed arm.

D152. The gripper (10) according to any of the preceding embodiments, wherein each arm is shaped to allow a positive locking between the gripper (10) and the item (7).

D153. The gripper (10) according to any of the preceding embodiments, wherein each arm comprises a latching portion (81) configured to latch into a portion of the item (7).

D154. The gripper (10) according to any of the preceding embodiments, wherein each arm is configured to allow a frictional locking between the gripper (10) and the item (7).

D155. The gripper (10) according to any of the preceding embodiments, wherein each arm comprises a contact edge (18) configured to contact the item (7).

D156. The gripper (10) according to the preceding embodiment and with the features of embodiment D131, wherein the contact edge (18) abuts the item space (8).

D157. The gripper (10) according to any of the 2 preceding embodiments, wherein the contact edge (18) comprises a coating with a high friction material.

D158. The gripper (10) according to any of the 3 preceding embodiments, wherein the coating comprises an anisotropic coefficient of friction such that the coefficient of friction is higher in a direction that separates the item (7) from the gripper (10) than in a direction that joins the item (7) with the gripper.

D159. The gripper (10) according to the preceding embodiment, wherein said anisotropic coefficient of friction is anisotropic in the axial direction.

D160. The gripper (10) according to any of the preceding embodiments, wherein the arm comprises a free end portion (19) which is a portion of the arm that is furthest from the housing (2).

D161. The gripper (10) according to the preceding embodiment, wherein the free end portion (19) comprises a contact edge (18) configured to contact the item (7) during gripping.

D162. The gripper (10) according to the preceding embodiment, wherein a gap between the contact edge (18) of the free end portion (19) and a central axis of the housing (2) parallel to the axial direction becomes narrower from a furthest position to a nearest position within the free end portion (19) with respect to the housing (2).

D163. The gripper (10) according to any of the 2 preceding embodiments, wherein the contact edge (18) of the free end portion (19) is a sloped edge.

D164. The gripper (10) according to any of the preceding embodiments, wherein the gripper (10) is configured to be driven along the axial direction by an actuator.

D165. The gripper (10) according to any of the preceding embodiments, wherein the gripper (10) is configured to be driven only along the axial direction by an actuator for the purpose of gripping an item (7).

D166. The gripper (10) according to any of the preceding embodiments, wherein the gripper (10) comprises an actuator configured to drive the shaft (4) along the axial direction.

D167. The gripper (10) according to any of the preceding embodiments, wherein the gripper (10) comprises an actuator configured to drive the shaft (4) only along the axial direction for the purpose of gripping an item (7).

D168. The gripper (10) according to any of 4 preceding embodiments, wherein the actuator is an electromagnetic, pneumatic or hydraulic actuator.

D169. The gripper (10) according to any of the preceding embodiments, wherein the gripper (10) further comprises at least one monitoring sensor (6).

D170. The gripper (10) according to the preceding embodiment, wherein the at least one monitoring sensor (6) is fixed with respect to the shaft (4).

D171. The gripper (10) according to any of 2 the preceding embodiments, wherein the at least one monitoring sensor (6) is configured to measure a position of the gripper head (9) along the axial direction.

D172. The gripper (10) according to any of the 3 preceding embodiments, wherein the at least one monitoring sensor (6) is configured to measure a change in the relative position between the gripper head (9) and the shaft (4).

D173. The gripper (10) according to any of the 4 preceding embodiments, wherein the at least one monitoring sensor (6) is configured to measure a motion, e.g., a rotation, of the at least one movable arm (12).

D174. The gripper (10) according to any of the 5 preceding embodiments, wherein the at least one monitoring sensor (6) is configured to detect presence of the housing (2) at one or more positions along the axial direction.

D175. The gripper (10) according to any of the 6 preceding embodiments, wherein the at least one monitoring sensor (6) comprises an optical sensor.

D176. The gripper (10) according to any of the 7 preceding embodiments, wherein the at least one monitoring sensor (6) comprises at least one reflex light barrier sensor.

D177. The gripper (10) according to any of the 8 preceding embodiments, wherein the at least one monitoring sensor (6) comprises a magnetic sensor configured to measure a strength and/or orientation of a magnetic field.

D178. The gripper (10) according to any of the 9 preceding embodiments, wherein the at least one monitoring sensor (6) comprises a sensor disk mounted on the shaft (4).

D179. The gripper (10) according to any of the 10 preceding embodiments, wherein the shaft (4) comprises at least one marker for facilitating a measurement of position of the shaft (4) along the axial direction.

D180. The gripper (10) according to any of the 11 preceding embodiments, wherein the at least one monitoring sensor (6) is configured such that its output is indicative of an accidental relative motion between the shaft (4) and the housing (2).

D181. The gripper (10) according to any of the preceding embodiments, wherein the gripper (10) comprises an arm motion limiter configured to set a limit, preferably selectively, on the range of motion of the at least one movable arm (12).

D182. The gripper (10) according to any of the preceding embodiments, wherein the gripper (10) is configured to move the item (7) along the axial direction.

D183. The gripper (10) according to any of the preceding embodiments, wherein the item (7) is a sample container.

D184. The gripper (10) according to the preceding embodiment, wherein the sample container comprises a lid (71).

D185. The gripper (10) according to the preceding embodiment, wherein the gripper (10) is configured to grip the item (7) by the lid (71).

D186. The gripper (10) according to any of the 2 preceding embodiments, wherein the gripper (10) is configured to grip the sample container such that the axial direction is parallel with a central axis of the sample container extending from the lid (71) to a bottom (73) of the sample container.

D187. The gripper (10) according to any of the preceding embodiments, wherein the gripper head (9) is configured to be mounted to the shaft (4) via the relative motion.

D188. The gripper (10) according to any of the preceding embodiments and with the features of embodiment D2, wherein the gripper head (9) is configured to be mounted to the shaft (4) by inserting the shaft (4) in the housing bore (21) of the gripper head (9).

D189. The gripper (10) according to any of the preceding embodiments, wherein the gripper head (9) is configured to be removable from the shaft (4).

D190. The gripper (10) according to any of the preceding embodiments, wherein the gripper head (9) is configured to be removable from the shaft (4) via the relative motion.

D191. The gripper (10) according to any of the preceding embodiments and with the features of embodiment D2, wherein the gripper head (9) is configured to be removable from the shaft (4) by removing the shaft (4) out of the housing bore (21) via the relative motion.

D192. The gripper (10) according to any of the preceding embodiments and with the features of embodiment D5, wherein the shaft (4) is configured to exit the housing bore (21) from the distal bore end (23).

D193. The gripper (10) according to any of the preceding embodiments, wherein at least one arm joint (30) is a rotational joint (30) and wherein at least one moveable arm (12) is a rotatable arm (12), wherein each rotatable arm (12) is rotatably joined to the housing via a respective rotational joint (30).

D194. The gripper (10) according to the preceding embodiment, wherein at least one rotational joint (30) comprises an arm axle (3).

D195. The gripper (10) according to any of the 2 preceding embodiments, wherein each rotational joint (30) comprises at least one angular degree of freedom.

D196. The gripper (10) according to any of the 3 preceding embodiments, wherein at least one rotational joint (30) is a flexure joint (30).

D197. The gripper (10) according to the preceding embodiment, wherein the housing (2) and each rotatable arm (12) that is joined to the housing (2) via a respective flexure joint (30) are made of a single part.

D198. The gripper (10) according to any of the preceding embodiments, wherein at least one arm joint (30) is a translational joint (30) and wherein at least one moveable arm (12) is a translatable arm (12), wherein each translatable arm (12) is joined to the housing via a respective translational joint (30) such that each translatable arm (12) is movable in a radial direction, wherein the radial direction is perpendicular to the axial direction.

D199. The gripper (10) according to any of the preceding embodiments, wherein the gripper head (9) is mounted on the shaft (4) such that rotation of the shaft (4) about the axial direction causes rotation of the gripper head (9) about the axial direction.

D200. The gripper (10) according to any of the preceding embodiments, wherein the gripper head (9) is rotationally locked with the shaft (4).

D201. The gripper (10) according to any of the preceding embodiments, wherein the gripper head (9) is mounted on the shaft (4) such that rotational motion about the axial direction of the gripper head (9) relative to the shaft (4) is prevented.

Below, system embodiments will be discussed. These embodiments are abbreviated by the letter “S” followed by a number. When reference is herein made to system embodiments, these embodiments are meant.

S1. A system comprising
at least one item (7);
a gripper (10) according to any of the preceding device embodiments;
wherein the gripper (10) is configured to grip the at least one item (7).

S2. The system according to the preceding embodiment, further comprising an actuator configured to actuate the gripper (10) along the axial direction.

S3. The system according to any of the preceding system embodiments, wherein each item (7) is a sample container.

S4. The system according to the preceding embodiment, wherein the sample container comprises a lid (71).

S5. The system according to the preceding embodiment, wherein the gripper (10) is configured to grip the item (7) by the lid (71).

S6. The system according to any of the 2 preceding embodiments, wherein the gripper (10) is configured to grip the sample container such that the axial direction is parallel with a central axis of the sample container extending from the lid (71) to a bottom (73) of the sample container.

S7. The system according to any of the preceding system embodiments, further comprising an analytical device configured to analyze a liquid.

S8. The system according to the preceding embodiment, wherein the analytical device is a chromatography device.

S9. The system according to any of the 2 preceding embodiments, wherein the analytical device is a liquid chromatography device.

S10. The system according to any of the 3 preceding embodiments, wherein the analytical device is a high-performance liquid chromatography device.

S11. The system according to any of the preceding system embodiments, further comprising an item identification system and wherein the gripper (10) is part of the item identification system.

S12. The system according to the preceding embodiment, wherein each item (7) comprises a label and wherein the item identification system is configured to identify each item (7) by sensing the respective label.

S13. The system according to any of the preceding system embodiments, further comprising an item tray configured to contain a plurality of items and containing the at least one item (7).

S14. The system according to any of the preceding system embodiments, wherein the gripper (10) is configured to move each item (7) along the axial direction.

S15. The system according to any of the preceding system embodiments, wherein the system further comprises a replacement gripper head for replacing the gripper head (9) of the gripper.

S16. The system according to the preceding embodiment, wherein the replacement gripper head is identical to the gripper head (9).

S17. The system according to the penultimate embodiment, wherein the replacement gripper head is configured to grip items with a different shape and/or size compared to the gripper head (9).

S18. The system according to any of the 3 preceding embodiments, wherein the replacement gripper head is configured to be mounted to the shaft (4), after removing the gripper head (9) from the shaft (4), via a motion of the shaft (4) along the axial direction.

S19. The system according to any of the preceding system embodiments, wherein the system further comprises a positioning system configured to move the gripper (10) along at least one direction that is different from the axial direction.

Below, use embodiments will be discussed. These embodiments are abbreviated by the letter “U” followed by a number. When reference is herein made to use embodiments, these embodiments are meant.

U1. Use of the gripper (10) according to any of the preceding device embodiments to grip an item (7).

U2. Use of the gripper (10) according to any of the preceding device embodiments to grip and move an item (7).

U3. Use of the gripper according to any of the preceding device embodiments D199 to D201 to grip, move and rotate an item (7)

U4. Use of the gripper (10) according to any of the preceding device embodiments in a chromatography system.

U5. Use of the gripper (10) according to any of the preceding device embodiments in a chromatography system to grip and move a sample container containing a liquid to be analyzed.

U6. The use according to the preceding embodiment, wherein the chromatography system is a liquid chromatography system.

U7. The use according to any of the 2 preceding embodiments, wherein the chromatography system is a high-performance liquid chromatography system.

U8. The use according to any of the preceding use embodiments, wherein the item (7) is a sample container.

Below, method embodiments will be discussed. These embodiments are abbreviated by the letter “M” followed by a number. When reference is herein made to method embodiments, these embodiments are meant.

M1. A method comprising:
gripping an item (7) with the gripper (10) according to any of the preceding device embodiments.

M2. The method according to the preceding embodiment, wherein gripping the item (7) comprises actuating the gripper (10) along the axial direction towards the item (7).

M3. The method according to any of the 2 preceding embodiments, wherein the gripper (10) comprises the features of embodiment D131, wherein gripping the item (7) comprises actuating the gripper (10) along the axial direction towards the item (7) until the item (7) is positioned in the item space (8) of the gripper.

M4. The method according to any of the 3 preceding embodiments, wherein the gripper (10) comprises the features of embodiment D12, wherein the method comprises keeping the gripper (10) in the closed position (105) prior to and while gripping the item (7).

M5. The method according to any of the preceding embodiments M1 to M3, wherein the gripper (10) comprises the features of embodiment D12, wherein the method comprises keeping the gripper (10) in the at least one open position (101) prior to gripping the item (7).

M6. The method according to the preceding embodiment, wherein the gripper (10) comprises the features of embodiment D16, wherein the at least one open position (101) is the distal open position (103).

M7. The method according to any of the 2 preceding embodiments, wherein gripping the item (7) comprises transitioning the gripper (10) from the at least one open position (101) to the closed position (105) by causing the relative motion between the shaft (4) and the gripper head (9).

M8. The method according to the preceding embodiment, wherein transitioning the gripper (10) from the at least one open position (101) to the closed position (105) comprises actuating the gripper (10) along the axial direction.

M9. The method according to any of the 2 preceding embodiments, wherein transitioning the gripper (10) from the at least one open position (101) to the closed position (105) comprises actuating the gripper (10) along the axial direction towards the item (7) after the gripper head (9) contacts the item (7).

M10. The method according to any of the preceding method embodiments, wherein the item (7) rests on an origin support structure prior to being gripped.

M11. The method according to any of the preceding method embodiments, wherein the method comprises lifting the item (7) with the gripper (10) by driving the gripper (10) along the axial direction, after gripping the item (7).

M12. The method according to the preceding embodiment, wherein the method comprises maintaining the gripper (10) in the closed position (105) while lifting the item (7).

M13. The method according to any of the 2 preceding embodiments, wherein the method comprises, after lifting the item (7) with the gripper, placing the item (7) on a destination support structure by driving the gripper (10) along the axial direction.

M14. The method according to the preceding embodiment, wherein the method comprises keeping the gripper (10) in the closed position (105) while placing the item (7) on the destination support structure.

M15. The method according to any of the 2 preceding embodiments and with the features of embodiment M10, wherein the origin support structure and the destination support structure are the same.

M16. The method according to any of the preceding method embodiments, wherein the method comprises releasing the item (7) from the gripper.

M17. The method according to the preceding embodiment, wherein the gripper (10) comprises the features of embodiment D12, wherein releasing the item (7) from the gripper (10) comprises transitioning the gripper (10) from the closed position (105) to the at least one open position (101) by causing the relative motion between the shaft (4) and the gripper head (9).

M18. The method according to the preceding embodiment, wherein the gripper (10) comprises the features of embodiment D13, wherein the at least one open position (101) is the proximal open position (102).

M19. The method according to any of the 2 preceding embodiments, wherein transitioning the gripper (10) from the closed position (105) to the at least one open position (101) comprises actuating the gripper (10) along the axial direction.

M20. The method according to any of the 3 preceding embodiments, wherein transitioning the gripper (10) from the closed position (105) to the at least one open position (101) comprises actuating the gripper (10) along the axial direction towards the item (7), while the item (7) rests on a support structure.

M21. The method according to any of the preceding method embodiments, wherein the gripper (10) comprises the features of embodiments D12 and D107, wherein the method comprises transitioning the gripper (10) from the at least one open position (101) to the closed position (105) by driving the gripper (10) along the axial direction such that the gripper head (9) abuts the stopper (5).

M22. The method according to any of the preceding method embodiments, wherein the gripper (10) comprises the features of embodiments D13, D16 and D107, wherein the method comprises transitioning the gripper (10) from the proximal open position (102) to the distal open position (103) by driving the gripper (10) along the axial direction such that the gripper head (9) abuts the stopper (5).

M23. The method according to any of the preceding method embodiments, wherein the gripper (10) comprises the features of embodiments D2, wherein the method comprises mounting the gripper head (9) to the shaft (4) by driving the shaft (4) along the axial direction towards the housing (2) such that the shaft (4) is inserted in the housing bore (21).

M24. The method according to any of the preceding method embodiments, wherein the gripper (10) comprises the features of embodiments D2, wherein the method comprises separating the gripper head (9) from the shaft (4) by driving the shaft (4) along the axial direction away from the housing (2) such that the shaft (4) exits the housing bore (21).

M25. The method according to any of the preceding method embodiments, wherein the gripper (10) comprises the features of embodiments D2, wherein the method comprises replacing the gripper head (9) by
separating a mounted gripper head (9) from the shaft (4) by driving the shaft (4) along the axial direction away from the housing (2) of the mounted gripper head (9) such that the shaft (4) exits the housing bore (21) of the mounted gripper head (9) and
mounting a new gripper head (9) to the shaft (4) by driving the shaft (4) along the axial direction towards the housing (2) of the new gripper head (9) such that the shaft (4) is inserted in the housing bore (21).

M26. The method according to any of the preceding method embodiments, wherein the method comprises rotating the shaft of the gripper around a rotational axis being parallel to the axial direction and wherein rotation of the shaft causes rotation of the gripper head around said rotational axis.

M27. The method according to the preceding embodiment, wherein the method comprises rotating the gripper head around the rotational axis to align the so that arms of the gripper fit in the space around the item.

M28. The method according to any of the preceding method embodiments, wherein the method comprises prior to gripping the item (7) aligning the gripper (10) with the item (7) using a positioning system configured to move the gripper (10) along at least one direction that is different from the axial direction.

M29. The method according to any of the preceding method embodiments, wherein the method comprises prior to placing the item (7) with the gripper (10) on a destination support structure aligning the gripper (10) with the destination support structure using a positioning system configured to move the gripper (10) along at least one direction that is different from the axial direction.

M30. The method according to any of the preceding method embodiments and with the features of embodiment M25, wherein the method comprises prior to mounting the new gripper head (9) aligning the shaft (4) with the housing bore (21) of the new gripper head (9) using a positioning system configured to move the gripper (10) along at least one direction that is different from the axial direction.

Below further device embodiments will be discussed.

D202. The gripper (10) according to any of the preceding device embodiments, wherein the gripper (10) is configured to carry out the method according to any of the preceding method embodiments M1 to M27.

### Below Further System Embodiments Will Be Discussed.

S20. The system according to any of the preceding system embodiments, wherein the system is configured to carry out the method according to any of the preceding method embodiments.

### BRIEF DESCRIPTION OF THE DRAWINGS

FIG. 1 depicts a cross-sectional view of a gripper.

FIG. 2 depicts an exploded cross-sectional view of the gripper;

FIG. 3 illustrates a gripping process of an item with the gripper;

FIG. 4 illustrates a releasing process of the item from the gripper;

FIG. 5 illustrates a resetting process of the gripper;

FIG. 6 depicts cross-sectional views of a gripper with a different shaft;

FIG. 7 depicts cross-sectional views of a gripper comprising a distal housing magnet;

FIG. 8 depicts cross-sectional views of a gripper comprising pins.

### DETAILED DESCRIPTION OF THE DRAWINGS

In the following, exemplary embodiments of the invention will be described, referring to the figures. These examples are provided to give further understanding of the invention, without limiting its scope.

In the following description, a series of features and/or steps are described. The skilled person will appreciate that unless explicitly required and/or unless required by the context, the order of features and steps is not critical for the resulting configuration and its effect. Further, it will be apparent to the skilled person that irrespective of the order of features and steps, the presence or absence of time delay between steps can be present between some or all of the described steps.

It is noted that not all the drawings carry all the reference signs. Instead, in some of the drawings, some of the reference signs have been omitted for sake of brevity and simplicity of illustration.

Embodiments of the present invention will now be described with reference to the accompanying drawings.

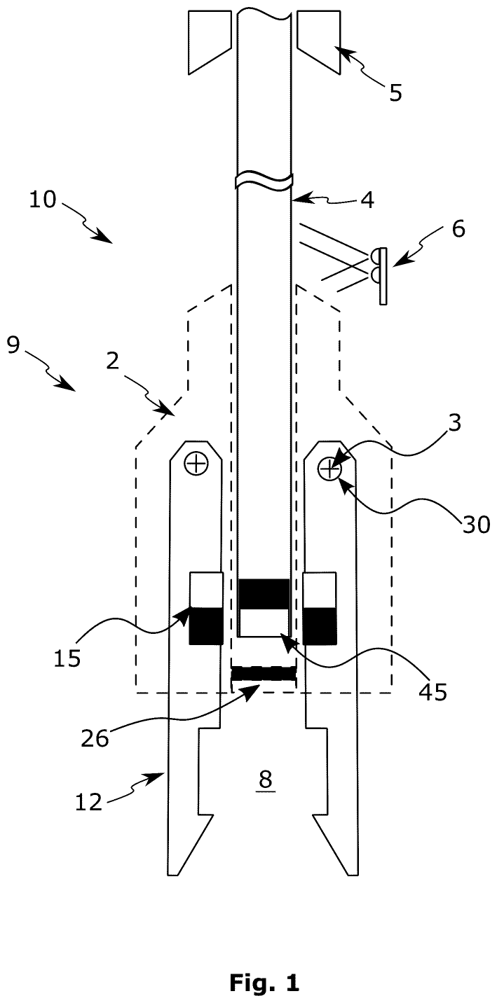

FIG. 1 is a cross-sectional view of a gripper 10. The gripper 10 comprises a gripper housing 2, in which, e.g., by means of axles 3, movable arms 12 can be rotatably mounted. Generally, each movable arm 12 can be joined to the housing 2 via a respective arm joint 30. Arm magnets 15 can be located in the rotatable arms 12. At the bottom of the housing 2, there can be a housing magnet 26, which can be a flat magnet 26. The housing magnet 26 can comprise reversed magnetic orientation with respect to the arm magnets 15. In the figures, the magnetic orientation is indicated by white and black filling corresponding to the north pole and south pole of the magnets. As a unit, the movable arms 12, housing 2 and axles 3 can form the gripper head 9.

The gripper head 9 can be slid onto a shaft 4. At the lower end of the shaft 4 can be a shaft magnet 45. Due to the reversed magnetic orientation of the shaft magnet 45 in relation to the orientation of the arm magnets 15, the gripper head 9 can be held in the rest position (i.e., gripper closed) by the mutual attraction. The distance between the housing magnet 26 and the shaft magnet 45 in the gripper axis can be such that the mutual attraction force in the rest position may not be sufficient to lift the housing 2. This can be the case until the shaft magnet 45 and the housing magnet 26 make contact.

A monitoring sensor 6, which can be a reflex light barrier 6, can be mounted in such a way that it follows the vertical movement of the gripping axis 4.

Moreover, a stopper 5 can be in a vertically invariable position.

The gripper 10 may comprise an item space 8 which can be occupied at least in part, by a gripped portion of an item.

The gripper head 9 can be mounted on the shaft 4 such that rotation of the shaft 4 about the axial direction causes rotation of the gripper head 9 about the axial direction. For example, the gripper head 9 can be mounted on the shaft 4 such that rotational motion about the axial direction of the gripper head (9) relative to the shaft (4) is prevented.

The cross-sectional view in FIG. 1 (and generally throughout the figures) is taken along a plane parallel to the axial direction.

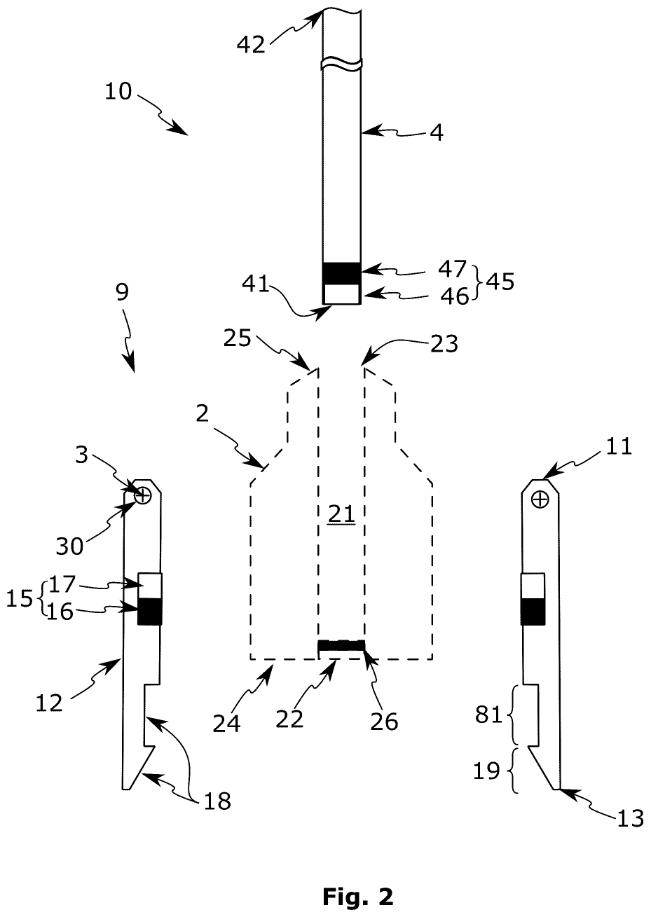

FIG. 2 illustrates an exploded cross-sectional view of the gripper 10. The cross-sectional view in FIG. 2 corresponds to the one depicted in FIG. 1. Furthermore, certain components of the gripper 10 have been deliberately separated to create the exploded view shown in FIG. 2. Thus, the depiction in FIG. 2 enhances the level of detail, offering a more comprehensive and intricate insight into the gripper's structure.

More particularly, in FIG. 2, the movable arms 12, housing 2 and the shaft 4 are depicted separated from each other. In general, the shaft 4 and the housing 2 can be separated from each-other as depicted in FIG. 2. This can be done via a relative motion along the axial direction between the shaft 4 and the housing 2. However, the movable arms 12 and the housing 2 can typically be inseparable from each other.

The shaft 4 can comprise a longitudinal structure. That is, one dimension of the shaft (i.e., the length) can be larger than the other two dimensions (i.e., width and depth). The larger dimension (i.e., the length) can be measured along the axial direction. The shaft 4 can thus extend longitudinally (i.e., along the axial direction) from a distal shaft end 42 to a proximal shaft end 41. The proximal shaft end 41 corresponds to the end of the shaft 4 that is inserted in the housing 2. The distal shaft end 42 is the end of the shaft opposite to the proximal shaft end 41.

The shaft 4 can comprise a shaft magnet 45, which can be a permanent magnet 45. The shaft magnet can be positioned near or at the proximal shaft end. For example, the shaft magnet 45 can be the most proximal portion of the shaft 4. The shaft magnet 45 can comprise a proximal shaft magnetic pole 46 and a distal shaft magnetic pole 47, which can be jointly referred to as shaft magnetic poles 46, 47. The shaft magnetic poles 46, 47 can be arranged along the axial direction. In particular, the proximal shaft magnetic pole 46 can be more proximal than the distal shaft magnetic pole 47. That is, the proximal shaft magnetic pole 46 can be closer to the proximal shaft end 41 than the distal shaft magnetic pole 47. It will be understood that the proximal shaft magnetic pole 46 and the distal shaft magnetic pole 47 comprise opposite polarities.

The housing 2 can extend along the axial direction from a distal housing end 25 to a proximal housing end 24. The shaft 4 can be inserted in the housing 2 from the distal housing end 25 towards the proximal housing end 24. The housing 2 can comprise a housing bore 21. The housing bore 21 can extend along the axial direction. It can be centrally located in the housing 2. The housing bore 21 can extend from the distal housing end 25 towards the proximal housing end 24. The housing bore 21 can comprise a distal bore end 23 and a proximal bore end 25. The distal bore end 23 can be an open end. Thus, the distal bore end 23 can allow access in the housing bore 21. The proximal bore end 22 can be a closed end. Thus, the housing bore 21 can be a blind bore.

The housing bore 21 can receive the shaft 4. Preferably, the housing bore 21 and the shaft 4 can be dimensioned to allow a clearance fit between each other. For example, the housing bore 21 can comprise a diameter that is slightly larger than the diameter of the shaft 4. The shaft 4 can thus slide inside the housing bore 21. On the one hand said sliding can allow relative motion between the shaft 4 and the gripper head 9 along the axial direction, which in turn causes motion of the at least one movable arm 12. On the other hand, said sliding can allow mounting and separating the gripper head 9 to/from the shaft 4.

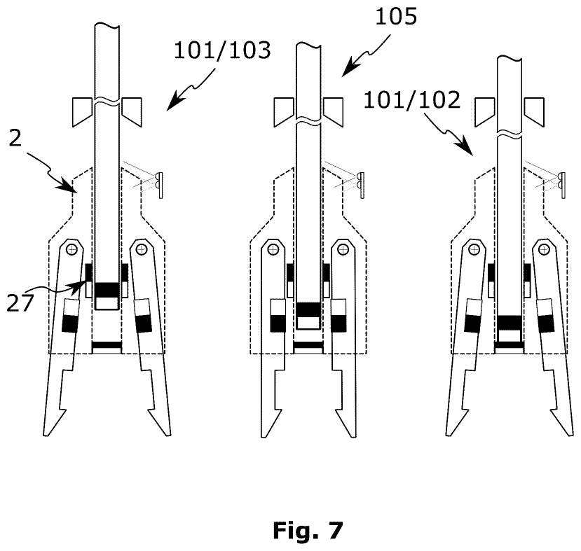

The housing 2 can comprise a housing magnet 26. Said magnet 26 can be positioned inside the housing bore 21. For example, the housing magnet 26 can be positioned near or at the proximal bore end 22. This can allow a direct contact between the shaft 4 and the housing magnet 26 when the shaft 4 can be fully inserted in the housing bore 21. The poles of the housing magnet 26 can be arranged along the axial direction. Moreover, the housing magnet 26 and the shaft magnet 45 can be arranged such that they can mutually attract each other when the shaft 4 is inserted in the housing bore 21. Said housing magnet 26 can be referred to as a proximal housing magnet 26 (as opposed to the distal housing magnet 27 shown in FIG. 7).

Each movable arm 12 of the gripper 10 can extend from a joint arm end 11 to a free arm end 13. Each movable arm can be mounted to the housing 2 near or at the joint arm end 11. Thus, the joint arm end 11 can be positioned inside the housing 2. The free arm end 13 can be opposite to the joint arm end 11. The free arm end 13 can be outside the housing 2. That is, each movable arm 12 can protrude outside the housing 2 beyond the proximal housing end 24.

At least one movable arm 12 can be rotatably mounted to the housing 2 via a respective axle 3. Said movable arm(s) 12 can thus rotate about the respective axle 3. Said axle 3 can be positioned near or at the joint arm end 11.

Each movable arm 12 can comprise a respective arm magnet 15. Each arm magnet 15 can comprise reverse magnetic orientation with respect to the shaft magnet 45. Similarly, each arm magnet 15 can comprise reverse magnetic orientation with respect to the proximal housing magnet 26. More particularly, each arm magnet 15 can comprise a proximal arm magnetic pole 16 and a distal arm magnetic pole 17, which can be jointly referred to as arm magnetic poles 16, 17. The arm magnetic poles 16, 17 can be arranged along a length of the arms 12. In particular, the proximal arm magnetic pole 16 can be more proximal than the distal arm magnetic pole 17. That is, the proximal arm magnetic pole 16 can be closer to the free arm end 13 than the distal arm magnetic pole 17. It will be understood that the proximal arm magnetic pole 16 and the distal arm magnetic pole 17 comprise opposite polarities.

Depending on the relative position between the gripper head 9 and the shaft 4, there can either be a mutual attraction or a mutual repulsion between the shaft magnet 45 and each arm magnet 45. When the mutual attraction is present, the gripper can be in a closed position. In the closed position, the arms 12 can be closest to each other and a size of the item space 8 can be at minimum. When the mutual repulsion is present, the gripper can be in an open position. In the open position the arms 12 can be furthest from each other and a size of the item space 8 can be at maximum.

Each movable arm 12 can comprise a contact edge 18 configured to contact the item while the item is being gripped. The contact edge 18 can preferably comprise a coating with a high friction material.

Each movable arm 12 can comprise a latching portion 81 which can be configured to latch into a portion of the item. The latching portion 81 can enable a positive locking between the gripper 10 and the item.

Each movable arm 12 can comprise a free end portion 19 which can be a portion of the movable arm 12 that is furthest from the housing 2. The contact edge 18 at the free end portion can be a sloped edge. In particular, a gap between the contact edge 18 of the free end portion 19 and a central axis of the housing 2 parallel to the axial direction becomes narrower from a furthest position to a nearest position within the free end portion 19 with respect to the housing 2.

The gripper can comprise two movable arms 12 which can be symmetrical with respect to a central axis of the gripper parallel to the axial direction. These can be referred to as opposite arms 12.

Throughout the Figures the gripper 10 is illustrated with two movable arms 12. It will be understood however that while preferable, it may not be necessary for the gripper 10 to comprise two movable arms 12. It is sufficient for the gripper 10 to comprise at least one movable arm 12. In general, the gripper 10 can comprise a plurality of arms, wherein at least one of which can be a movable arm 12. It should be noted that at least one of the arms can be a fixed arm, although it is not depicted here. The fixed arm may resemble the movable arm 12, differing only in its inability to move relative to the housing. This means that the fixed arm can incorporate all the characteristics described both above and below in connection with the movable arm 12, with the exceptions being the absence of an axle 3, of the movable mounting to the housing 2, and of the arm magnet 15. That is, the fixed arm may not have an axle 3 or an arm magnet 15, and it can be securely affixed to the housing 2. Furthermore, it will also be understood that the gripper 10 may also comprise more than two movable arms 12, e.g., three movable arms 12.

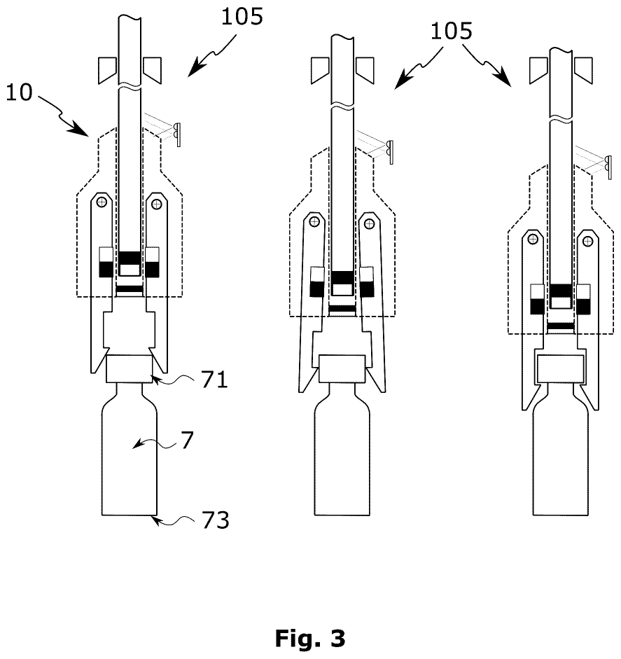

FIG. 3 illustrates a gripping process of an item 7 via the gripper 10. The first illustration on the left shows a first contact between the gripper 10 and the item 7. The second illustration in the middle shows the gripper 10 and the item 7 after the first contact but before gripping is established. The third illustration on the right shows the gripper 10 and the item 7 after gripping is established. As depicted in the third illustration, while the item 7 is being gripped by the gripper 10, a portion of the item 7 (in this example the lid 71) is positioned in the item space 8.

In this example, throughout the gripping process, the gripper 10 is in a closed position 105. This means that the shaft 4 and the gripper head 9 are positioned relative to each other such that a mutual attraction force exists between the shaft magnet 45 and each arm magnet 15. Said force attracts the movable arms 12 towards the shaft 4, which allows for a strong gripping of the item 7. Additionally, the mutual attraction force can maintain a stable position between the gripper head 9 and the shaft 4, hindering relative motion between the two.

The gripper 10 can be in a closed position 105 before and while gripping an item 7, which in this example is a sample container 7. The sample container 7 can comprise a lid 71 and a bottom 73. By moving the gripper 10 towards the item 7, the item 7 (e.g., the lid 71 of the sample container 7) can push the movable arms 12. This can be facilitated by the sloped contact edge 18 on the free end portion 19 of the movable arms 12. Thus, the movable arms 12 can slide over the edge of the item 7. Projections on the arms 12 (e.g., the latching portion 81) can hook onto the item (e.g., onto the lower edge of the lid 71) or onto a projection on item, and a firm connection can be created between the gripper and the item (i.e., positive locking). An attractive magnetic force can act between the arm magnets 15 and the shaft magnet 45, preventing the arms 12 from opening unintentionally.

Due to the frictional force between the contact edge 18 and the item 7, the gripper head 9 can move slightly towards the shaft along the axial direction relative during the opening of the gripping arms (illustrated by the middle sketch). This can change an alignment between the arm magnets 15 and the shaft magnet 45 such that the closing force of the gripper arms 12 (i.e., mutual attraction between said magnets 15, 45) is reduced. This movement can be referred to as deflection. The extent of the deflection can be determined via the sensor 6, which can be a reflex light barrier 6. For example, the more the gripper head 9 deflects, the more the housing 2 pushes in front of the reflex light barrier 6. This behavior can be used to detect an unintentional collision of the gripper head 9 and prevent damage.

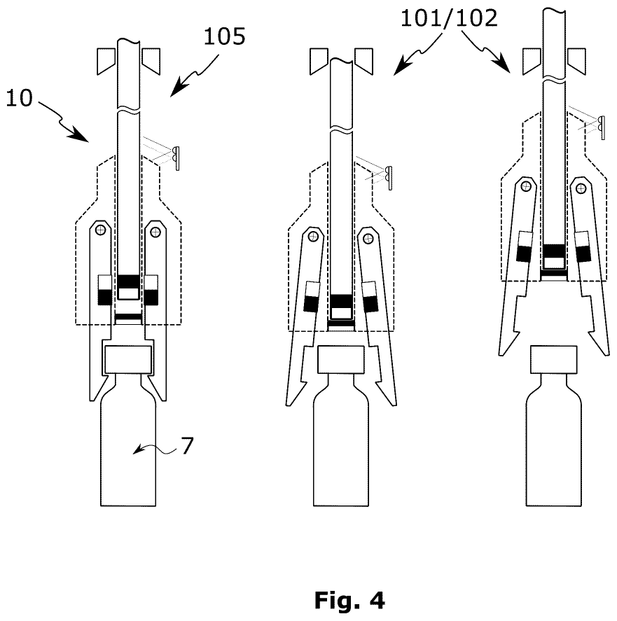

FIG. 4 illustrates a releasing process of an item 7 via the gripper 10, after the item 7 has been gripped. The first illustration on the left shows the gripper 10 in a closed position 105 and the item 7 being gripped by the gripper 10. Said illustration corresponds to the third illustration of FIG. 3. The second illustration in the middle of FIG. 4 shows the gripper 10 after a relative motion between the shaft 4 and the gripper head 9. The relative motion transitions the gripper from the closed position 105 to an open position 101 and more particularly to a proximal open position 101 (as opposed to a distal open position 103 in FIG. 7). As a result of the relative motion, the movable arms 12 have been moved (in the depicted example rotated) away from the shaft 4. In particular, via the relative motion, the relative position between the shaft 4 and gripper head 9 changes. More particularly, the item 7 may be gripped and transported in the configuration shown in FIG. 4, left panel. Once it is transported to its final location, the item 7 may be put on the final location, e.g., a bench top. This may be achieved by moving the shaft 4 of the gripper 10 downwardly. As long as the item 7 is not supported, the shaft 4 will remain in substantially the same or similar longitudinal position with respect to the gripper head 9. In particular, there will be an attractive force between the magnets 15 and 45 maintaining the gripper 10 in the closed position. Once the item 7 is supported, e.g., stands on a bench top, moving the shaft 4 further down will result to there being a relative longitudinal motion between the shaft 4 and the gripper head 9, as the gripper head 9 is hindered from moving down. This also leads to another relative position between the shaft magnet 45 and the arm magnets 15, thus resulting in a repulsive force moving the arms 12 outwardly and releasing the item (see FIG. 4, central panel). Further, there will be an attractive force between the shaft magnet 45 and the magnetic element 26. If moving the shaft 4 upwardly (see FIG. 4, right panel), both the shaft 4 and the gripper head 9 will thus move upwardly. In other words, as depicted in FIG. 4, central panel, the relative position between the shaft magnet 45 and each arm magnet 15 changes such that a mutual repulsion force is created between the shaft magnet 45 and each arm magnet 15. The movable arms 12 are therefore pushed away from the shaft. A further consequence of the relative motion can be the insertion of the shaft 4 further into the housing bore 21 such that it can contact the proximal housing magnet 26. The attachment between the shaft magnet 45 and the proximal housing magnet 26 can keep the gripper head 9 attached to the shaft 4. The proximal open position is thus a stable position between the gripper head 9 and the shaft 4, hindering relative motion between the two. The third illustration on the right shows the gripper 10 in the open position 101, 102 and moved away from the item 7 along the axial direction. As depicted in the third illustration, the gripper head 9 and the shaft 4 are moved together away from the item 7.

In this example, during the releasing process, the gripper 10 transitions from the closed position 105 to the open position 101 and in particular to the proximal open position 102. In each open position 101, the shaft 4 and the gripper head 9 are positioned relative to each other such that a mutual repulsion force exists between the shaft magnet 45 and each arm magnet 15. Said force pushes the movable arms 12 away from the shaft 4.

Still with reference to FIG. 4, after the item 7 has been moved (e.g., raised and lowered) to the same or another position within the action range of the gripper 10, the item can be set down again. For this purpose, the shaft 4 can be moved further in the housing as compared to the closed position 105. This can result in a relative movement between the gripper head 9 and the shaft 4, since the gripper head 9 is inhibited from further movement along the axial direction (i.e., spring deflection) by the placement of the item in a support structure. This relative movement can change the relative position between the magnets 15, 45. Said change on the one hand, causes the gripper arms 12 to be pushed outwards away from the item 7. On the other hand, the housing magnet 26 comes into the vicinity of the shaft magnet 45 and is attracted by it. As a result, a stable opening position 101, 102 can be achieved. As a result, the coupling between the gripper 10 and the item 7 can be removed and the gripper 10 can be moved upwards without the item 7. The spring deflection and also the assumption of the stable opening position 101, 102 can be monitored by the sensor 6.

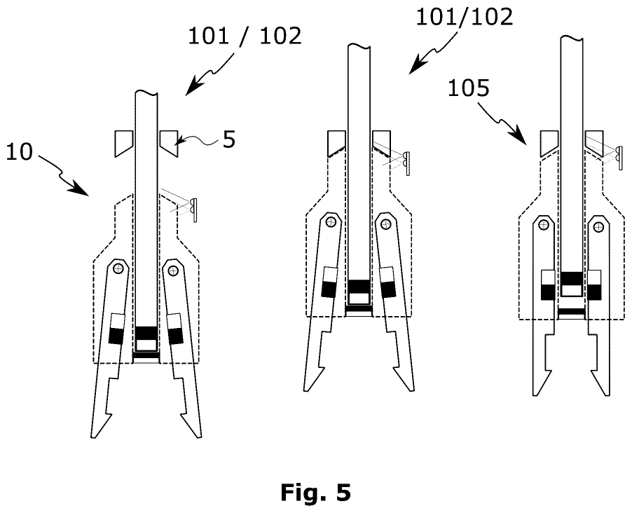

FIG. 5 illustrates a resetting process of the gripper 10. The resetting processing allows reusing the gripper 10 after a gripping & releasing process has occurred. The first illustration on the left shows the gripper 10 in an open position 101 and in particular in the proximal open position 102, wherein the shaft magnet 45 is attached to the proximal housing magnet 26. Said illustration corresponds to the third illustration of FIG. 4. The second illustration in the middle of FIG. 4 shows the gripper 10 moved along the axial direction toward the stopper 5 until the gripper head 9 contacts the stopper 5. More particularly, the distal housing end 25 (see FIG. 2) contacts the stopper 5. The stopper 5 is fixed along the axial direction. As such, further motion of the gripper 10 along the axial direction pushing the gripper head 9 against the stopper 5 will generate a separating force exerted from the stopper 5 to the gripper head 9 until relative motion between the gripper hear 9 and the shaft 4 occurs. Thus, the shaft magnet 45 can be separated from the housing magnet 26. The third illustration on the right shows the gripper 10 and the item 7 after said relative motion occurs which transitions the gripper 10 out of the open position 101, 102. As depicted in the third illustration, the gripper 10 can be reset in the closed position 105, from which a gripping process may proceed (as illustrated in FIG. 3). The third illustration corresponds to the first illustration of FIG. 3.

Before the shaft 4 reaches its uppermost (i.e., most distal) position along the axial direction, a stopper 5 can prevents further upward movement of the gripper head 9. This in turn can cause a relative movement between the shaft 4 and the gripper head 9. As a result, the housing magnet 25 can move away from the shaft magnet 45. Thus, the shaft magnet 45 can be positioned again in the starting position in which it attracts the arm magnets 15. This causes the movable arms 12 to close.

General reference will now be made to FIGS. 3 to 5. Again, it will be understood that FIG. 3 depicts the process of the gripper 10 gripping an item 7. FIG. 4 depicts the process of the gripper 10 releasing an item, and FIG. 5 depicts the process of transitioning the gripper 10 from a stable open position (corresponding to FIG. 4, right panel) to a stable closed position (corresponding to FIG. 3, left panel). In particular, it will be understood that all these processes are driven by longitudinally moving the shaft 4. Only by means of longitudinally moving the shaft 4, the item 7 is gripped in FIG. 3, only by means of longitudinally moving the shaft 4, the item 7 is released in FIG. 4, and only by means of longitudinally moving the shaft 4, the gripper 10 is reset in FIG. 5. In other words, only a longitudinal drive of the shaft 4 is used for the complete process. This renders the gripper 10 particularly simple.

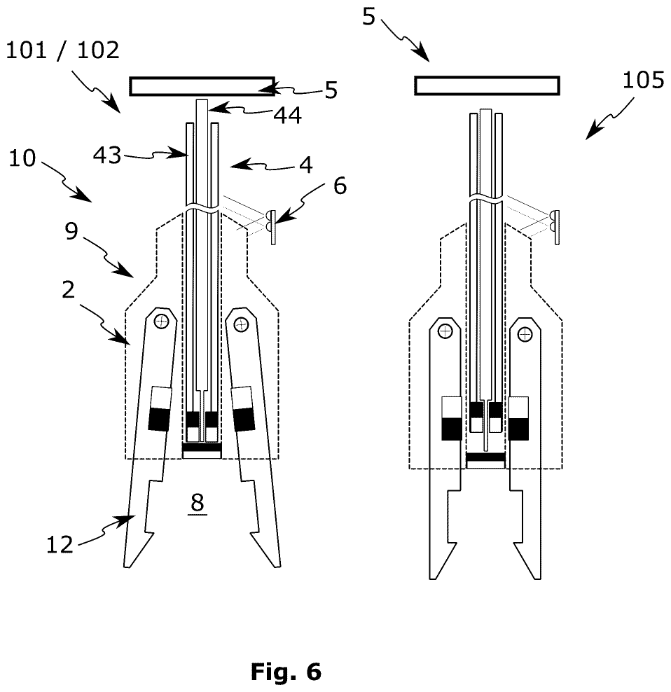

FIG. 6 depicts a cross-sectional view of a gripper 10 with a different shaft 4. As illustrated, the shaft can be hollow. In particular, it can comprise a shaft hollow component 43 accommodating a shaft pin 44, such that the shaft pin 44 can slide inside the shaft hollow component 43. The shaft magnet 45 can be provided with a bore. The gripper is returned to the closed position by means of the shaft pin 44 which can be moved against the stopper 5 when the gripper 10 is raised. This can leave the installation space around the shaft 4 above the housing 2 free for other assemblies.

In FIG. 6, the first illustration on the left illustrates the gripper 10 in the open position 101, in particular in the proximal open position 102, and while the shaft pin 44 contacts the stopper 5. The second illustration on the right illustrates the gripper 10 in the closed position 105.

FIG. 7 depicts a cross-sectional view of a gripper 10 comprising a distal housing magnet 27. The distal housing magnet 27 can enable a distal open position 103. Thus, in such embodiments, the gripper 10 may comprise three stable relative positions which can be: a distal open position 103 as illustrated in the first illustration on the left, a closed position 105 as illustrated in the second illustration in the middle and a proximal open position 102 as illustrated in the third illustration on the right.

That is, if the housing 2 is moved downwards along the axial direction beyond the closed position 105 relative to the shaft 5, the movable arms 12 open again (see FIG. 7, left panel). To keep the housing 2 stable in this position as well, a distal housing magnetic element 27 can be attached to the housing 2 above the plane of the arm magnets 15. The distal housing magnetic element 27 can be a second annular permanent magnet 27 or a ferromagnet 27. In such embodiments, the housing 2 can initially be pushed into the distal open position 103. When it is placed on the item 7, the housing 2 can be moved upwards along the axial direction relative to the shaft 4 so far that the movable arms 12 close (put differently, the shaft 4 can be moved downwards with respect to the housing 2, as depicted in FIG. 7, central panel). The gripper 10 can thus be transitioned into the closed position 105. The item 7 can now be moved in this position. Subsequently, when the item 7 is set down, the shaft 4 move down lower (i.e., can be inserted further into the housing 2) and the housing 3 can move up further relative to shaft 2 (see FIG. 7, right panel). This can cause the movable arms 12 to open again. Then, the shaft 4 (without the item 7) can move up against the stopper 5, moving the housing down past the closing position 105 to the distal open position 103.

In other words, when the gripper 10 is configured to comprise the distal open position 103, the gripper 10 can be transitioned from the proximal open position 102 to the distal open position 103 by utilizing the stopper 5. This can be done similarly to the resetting process illustrated in FIG. 5.

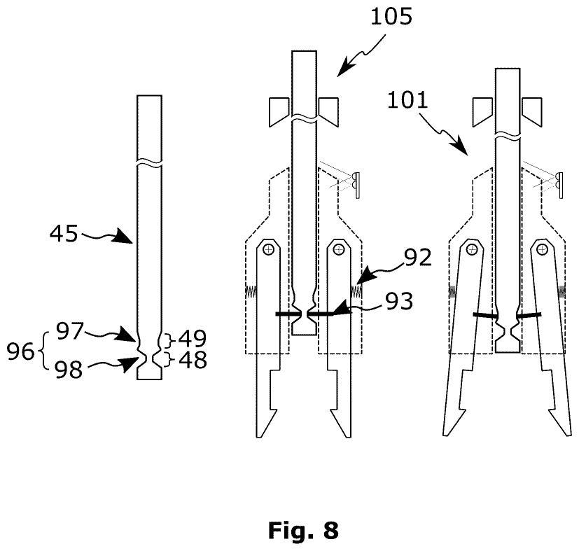

FIG. 8 depicts cross-sectional views of a gripper 10 comprising pins.

In particular, the first illustration on the left shows a cross-sectional view of the shaft 4 which comprises pin slots 96. A first one of the pin slots 96 can be an open position pin slot 97 and a second one of the pin slots 96 can be a closed position pin slot 98. The pin slots 96 can be provided at different locations along the axial direction. Each pin slot 96 can for example be a groove around a perimeter of the shaft 4.

The gripper 10 may further comprise pins. These can be the arm pins 93 firmly attached to the movable arms 12 as illustrated in FIG. 8 and/or housing pins (not shown) firmly attached to the housing 2. The pins can protrude towards and inside the housing bore 21 such that they can contact the shaft 4.

The pin slots 96 can be configured to receive a portion of a respective pin, such that when the portion of the respective pin is received therein, the gripper head and the shaft remain attached to each other. As such, each pin slot 96 can define a respective stable relative position of the gripper 10 wherein relative motion between the gripper head 9 and the shaft 4 along the axial direction is hindered. In particular, in each stable relative position of the gripper 10, the pins can be aligned with the pin slots 96 and a portion of the pins can be received in a respective one of the pin slots 96.

It can be preferably to comprise at least two pin slots 96, namely: the open position pin slot 97 which keeps the housing 2 stable with respect to the shaft when the pins are received therein during an open position 101 of the gripper 10 and a closed position pin slot 98 which keeps the housing 2 stable with respect to the shaft when the pins are received therein during the closed position 105 of the gripper 10.

The shaft 4 may comprises a narrow shaft portion 48 and a wide shaft portion 49 comprising different positions along the axial direction. The narrow shaft portion can comprise a first shaft width and the wide shaft portion can comprise a second shaft width larger than the first shaft width. The narrow shaft portion 48 can define the closed position 105 and the wide shaft portion 49 can define an open position 101. The gripper 10 may comprise multiple wide shaft portions 49 defining multiple open positions 101, such as, the proximal open position 102 and the distal open position 103.

During the closed position 105 of the gripper, the arm pins 93 can be aligned with the narrow shaft portion 48 such that they are at the same or similar position along the axial direction. The narrow shaft portion 48 can comprise a smaller width than the rest of the shaft 4 allowing for the movable arms 12 to become closer to each other. During the open position 101 of the gripper the arm pins 93 can be aligned with the wide shaft portion 49 such that they are at the same or similar position along the axial direction. The wide shaft portion 49 can comprise a larger width than the narrow shaft portion 48 allowing for the movable arms 12 to become further from each other.

A biassing mechanism 92 (e.g., a flexible element 92, such as a spring 92) can be provided pushing the movable arms 12 closer to each other. The biasing mechanism 92 can allow for a stronger grip of the item 7.

The gripper 10 can be configured such that during the closed position 105, the arm pins 93 can be at the same or similar position along the axial direction with the narrow shaft portion 48 and at least one pin can be at the same or similar position along the axial direction with the closed position pin slot 98. Similarly, the gripper 10 can be configured such that during the open position 101 the arm pins 93 can be at the same or similar position along the axial direction with the wide shaft portion 49 and at least one pin can be at the same or similar position along the axial direction with the open position pin slot 97. The gripper 10 can be configured for the above via the positioning of the pins, pin slots 96 and the narrow and wide shaft portions 48, 49.

Preferably, as illustrated in FIG. 8, the closed position pin slot 98 can be provided at the narrow shaft portion 48 and the open position pin slot 97 can be provided at the wide narrow shaft portion 49. As such, opening or closing the movable arms 12 and stabilizing the gripper head 9 with respect to the shaft 4 can be achieved simultaneously.

In general, the gripper 10 may comprise a locking mechanism for keeping the gripper head 9 attached to the shaft 4 (i.e., for hindering relative motion along the axial direction between the two) at select relative positions between the two. The locking mechanism may be implemented via the arm pins 93 and/or housing pins (not shown) and the pin slots 96, as described with reference to FIG. 8.

Variations of the above embodiments include the following.

Instead of the permanent magnet 26, the proximal housing magnetic element 26 can also be made of ferromagnetic material.

The housing 2 can also be designed with one or more holes.

Instead of using a permanent magnet 26, latching positions can also be generated in another way (e.g., push pin(s) on the housing 2 that can latch into recesses in the shaft 4).

The stop that limits the opening of the movable arms 12 can be adjusted when the stopper is approached. In this way, different degrees of opening can also be realized to extend the size range of items that can be gripped.

A sensor disk can be mounted on the shaft 4 to determine the relative position between the shaft 4 and the gripper head 9. Alternatively, or additionally, the shaft 4 can be designed for position measurement (e.g. shape, printing, surface modification, etc.).

The relative position between the shaft 4 and the gripper head 9 can be measured by means of the alignment of a magnetic field. Similarly, the degree of motion, e.g., rotation, of the movable arms 12 can be measured by means of the alignment of a magnetic field.

To determine the degree of spring deflection, the strength or orientation of a magnetic field can also be used.

Instead of using the latching portion 81 to hold the item 7, static friction between the arms and the item can also be used (i.e., frictional locking instead of positive locking). An appropriate coating can also be used. For example, a surface on the arms with an anisotropic coefficient of friction can be used (e.g., certain velvets). This can allow better sliding on the item 7 in combination with a good holding force when moving the item 7.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, preferred embodiments have been described with reference to the accompanying drawings, the skilled person will understand that these embodiments were provided for illustrative purpose only and should by no means be construed to limit the scope of the present invention, which is defined by the claims.

1. A gripper for gripping an item comprising:
a shaft extending longitudinally along an axial direction;
a gripper head mounted on the shaft such that it is allowed to slide along the axial direction with respect to the shaft;
wherein the gripper head comprises:
a housing; and
at least one movable arm, wherein each movable arm is movable relative to the housing;
wherein a relative motion along the axial direction between the shaft and the gripper head causes the at least one movable arm to move.

2. The gripper according to claim 1, wherein the gripper head comprises an item space configured to be occupied, at least in part, by a portion of the item and wherein a size of the item space is dependent upon motion of the at least one movable arm.

3. The gripper according to claim 1, further comprising at least one arm magnet firmly attached to a respective one of the at least one movable arm and wherein the shaft comprises a shaft magnet firmly attached to the shaft.

4. The gripper according to claim 1, wherein the relative motion arranges the gripper head in different relative positions with respect to the shaft;
wherein some of the relative positions are stable positions, wherein in each stable position a holding force keeps the gripper head and the shaft fixed to each other;
wherein the stable positions comprise at least one open position and a closed position;
wherein in each of the at least one open position, the at least one movable arm is positioned to allow release of the item, and in the closed position, the at least one movable arm is positioned to grip the item.

5. The gripper according to claim 1, further comprising at least one arm magnet firmly attached to a respective one of the at least one movable arm and wherein the shaft comprises a shaft magnet firmly attached to the shaft;
wherein the relative motion arranges the gripper head in different relative positions with respect to the shaft;
wherein some of the relative positions are stable positions, wherein in each stable position a holding force keeps the gripper head and the shaft fixed to each other;
wherein the stable positions comprise at least one open position and a closed position;
wherein in each of the at least one open position, the at least one movable arm is positioned to allow release of the item, and in the closed position, the at least one movable arm is positioned to grip the item.

6. The gripper according to claim 5, wherein the shaft magnet and the at least one arm magnet are arranged such that
in each of the at least one open position, there is a dominant magnetic repulsion force between the shaft magnet and each of the at least one arm magnet and
in the closed position, there is a dominant magnetic attraction force between the shaft magnet and each of the at least one arm magnet.

7. The gripper according to claim 5,
wherein the housing comprises a proximal housing magnetic element;
wherein the shaft magnet and the proximal housing magnetic element are configured such that there is a magnetic attraction force between the shaft magnet and the proximal housing magnetic element;
wherein one of the at least one open position is a proximal open position;
wherein the holding force, while the gripper is in the proximal open position, comprises said magnetic attraction force between the shaft magnet and the proximal housing magnetic element.

8. The gripper according to claim 5,
wherein the housing comprises a distal housing magnetic element;
wherein the shaft magnet and the distal housing magnetic element are configured such that there is a magnetic attraction force between the shaft magnet and the distal housing magnetic element;
wherein one of the at least one open position is a distal open position;
wherein the holding force, while the gripper is in the distal open position, comprises said magnetic attraction force between the shaft magnet and the distal housing magnetic element.

9. The gripper according to claim 4, further comprising at least one arm pin, wherein each arm pin is attached to a respective movable arm and protrudes from the respective movable arm towards the shaft and
wherein the shaft comprises a narrow shaft portion and a wide shaft portion comprising different positions along the axial direction and wherein
the narrow shaft portion comprises a first shaft width,
the wide shaft portion comprises a second shaft width larger than the first shaft width;
wherein when the gripper is in the closed position each arm pin contacts the shaft at the narrow shaft portion;
wherein when the gripper is in the at least one open position each arm pin contacts the shaft at the narrow shaft portion.

10. The gripper according to claim 4, further comprising a locking mechanism, wherein the locking mechanism is configured to keep the gripper head and the shaft attached to each other during at least some of the stable positions.

11. The gripper according to claim 1, further comprising a stopper configured to remain fixed along the axial direction and wherein the stopper is configured to limit the range of motion of the gripper head along the axial direction.

12. The gripper according to claim 1, further comprising a stopper configured to remain fixed along the axial direction;
wherein the shaft comprises a shaft hollow component and a shaft pin, wherein the shaft pin is inserted through the shaft hollow component and wherein the shaft pin is allowed to move along the axial direction with respect to the shaft hollow component;
wherein the stopper is configured to limit the range of motion of the shaft along the axial direction.

13. A system comprising
at least one item;
a gripper for gripping an item, the gripper comprising:
a shaft extending longitudinally along an axial direction;
a gripper head mounted on the shaft such that it is allowed to slide along the axial direction with respect to the shaft;
wherein the gripper head comprises:
a housing; and
at least one movable arm, wherein each movable arm is movable relative to the housing;
wherein a relative motion along the axial direction between the shaft and the gripper head causes the at least one movable arm to move;
wherein the gripper is configured to grip the at least one item.

14. The system according to claim 13, further comprising an analytical device to analyze a liquid, wherein the analytical device is a chromatography device.

15. A method comprising gripping an item with a gripper, comprising the gripper comprising:
a shaft extending longitudinally along an axial direction;
a gripper head mounted on the shaft such that it is allowed to slide along the axial direction with respect to the shaft;
wherein the gripper head comprises:
a housing; and
at least one movable arm, wherein each movable arm is movable relative to the housing;
wherein a relative motion along the axial direction between the shaft and the gripper head causes the at least one movable arm to move
